(19) United States
(12) Patent Application Publication
(10) Pub. No.: US 2012/0098839 A1
(43) Pub. Date: Apr. 26, 2012

(54) IMAGE REPRODUCTION DEVICE, IMAGE REPRODUCTION METHOD AND PROGRAM

(75) Inventors: Toshitaka KUMA, Osaka City (JP); Akihiko YAMADA, Daito City (JP)

(73) Assignee: SANYO ELECTRIC CO., LTD., Moriguchi City (JP)

(21) Appl. No.: 13/278,863

(22) Filed: Oct. 21, 2011

(30) Foreign Application Priority Data
Oct. 21, 2010 (JP) 2010-236922
Nov. 22, 2010 (JP) 2010-259718

(51) Int. Cl. G06T 1/00

(52) U.S. Cl. 345/501

(57) ABSTRACT

There is provided an image reproduction device including: a target image selection portion that selects, according to a selection operation, n sheets of target images from m sheets of input images (m and n are integers of two or more, and m>n), the selected n sheets of target images being sequentially displayed on a display screen such that slide show reproduction is performed; an image classification portion that classifies the m sheets of input images into a plurality of classes based on an image feature quantity extracted from each of the input images; and a display control portion that displays, when an input of the selection operation is received, the input images on the display screen in an arrangement based on a result of the classification of the image classification portion.

This nonprovisional application claims priority under 35 U.S.C. §119(a) on Patent Application No. 2010-259718 filed in Japan on Nov. 22, 2010 and Patent Application No. 2010-236922 filed in Japan on Oct. 21, 2010, the entire contents of which are hereby incorporated by reference.

### BACKGROUND OF THE INVENTION

1. Field of the Invention

The present invention relates to an image reproduction device, an image reproduction method and a program for reproducing an image.

2. Description of Related Art

As a method of reproducing a plurality of input images, there is a reproduction method using a slide show. In the reproduction method using a slide show, input images that are selected as a reproduction target are sequentially displayed one by one at given time intervals. Before the slide show is reproduced, a user can select a desired reproduction target from a large number of input images recorded in a recording medium.

An example of a display screen that is displayed when an image reproduction device receives an operation of selecting a reproduction target is shown in FIG. 33 (in FIG. 33, a diagonally shaded region represents an enclosure portion of a display device). In the display screen, a plurality of input images recorded in a recording medium are displayed in a matrix, and a check box is allocated to each of the input images. A user uses a pointing device or the like to check the check box of an input image that the user desires to select as a reproduction target, and can thereby select the input image as the reproduction target. In the conventional method shown in FIG. 33, the recorded input images are simply arranged on the display screen either in order of shooting time or in order of file number.

As, for example, the recording capacity of a recording medium has been increased in recent years, a user easily shoots digital images one after another, and often shoots a large number of sheets of similar images in a short time period (for example, the user often shoots the same person with substantially the same composition in the background of the same scenery a large number of times). When all similar images (hereinafter also referred to as a similar image group) are reproduced, it is likely that the similar images are displayed one after another and the details of the display are redundant, and a time period necessary for the reproduction is increased. Hence, an operation of selecting, as a reproduction target, only typical input images that are desired to be reproduced from among the similar image group is generally performed.

On the other hand, while a slide show is being reproduced, the user may desire to change the reproduction target. For example, although the reproduction of the slide show is started with the second input image selected as the reproduction target from the first to fourth input images constituting the similar image group, during the reproduction of the slide show, the user may realize that an image suitable as the reproduction target is not the second input image but the third input image. In this case, the user of a conventional image reproduction device temporarily stops the reproduction of the slide show, newly selects the reproduction target, and then restarts the reproduction of the slide show. A display screen for newly selecting the reproduction target is the same display screen as show in FIG. 33. In other words, the same display screen and the same selection method are used both for the first selection of the reproduction target and for the reselection of the reproduction target.

As described above, in the conventional method as shown in FIG. 33, the recorded input images are simply arranged on the display screen either in order of shooting time or in order of file number. Hence, the user often has difficulty in intuitively finding which image group forms the similar image group among the input images recorded in the recording medium. That is because similar images may be displayed in display positions away from each other, and the similar images may fail to be displayed within one screen. Consequently, it may be difficult to select, as the reproduction target, only typical input images from among the similar image group. In comparison with such a conventional method, if a user interface that makes it easy to select input images desired by the user is available, that is convenient.

As described above, in the conventional image reproduction device, the same display screen and the same selection method are used both for the first selection of the reproduction target and for the reselection of the reproduction target. Specifically, for example, as described above, when the input image selected as the reproduction target is desired to be changed from the second input image to the third input image, the user needs to find and select the desired third input image from all the input images while scrolling, as necessary, the display image as shown in FIG. 33. Since this type of operation is complicated, if the user interface that makes it easy to select input images desired by the user is available, that is convenient.

A method of extracting, based on similarity between a plurality of input images, typical input images from the input images and reproducing only the typical input images in a slide show is suggested; this method does not facilitate the realization of the user interface as described above.

In the typical slide show reproduction method, input images included in the reproduction target are simply arranged either in order of file number or in order of generation time and are sequentially displayed on a display screen one by one at given time intervals. In general, the file numbers are given according to the order of generation time. Hence, in the reproduction of the slide show, the reproduction is basically performed in chronological order, and, depending on input images, reproduction images as a whole may produce image effects similar to those of a story.

On the other hand, the image reproduction device often has the function of processing input images. The processing of the input images refers to the change of the brightness, the chroma or the hue of the input images, the enlargement or the reduction of the image size of the input images or the like.

It is now assumed that, as shown in FIG. 56, input images 901 to 903 are shot with a digital camera, then the input image 901 is processed and thus an input image 904 is generated and thereafter an input image 905 is shot. In this case, in general, file numbers that are continuous numbers are given, in order of generation time, to five image files that store the input images 901 to 905, and then the image files are recorded in a recording medium such as a semiconductor memory.

Hence, when a slide show including the input images 901 to 905 as the reproduction target is reproduced, as shown in FIG. 57, the input images 901, 902, 903, 904 and 905 are sequentially reproduced in this order.

Digital cameras that can shoot a still image while shooting a moving image are widely used. Consider a case where, in this type of digital camera, as shown in FIGS. 58A and 58B, still images 912 and 913 are shot while a moving image 911 is being shot, and after the completion of the shooting of the moving image 911, still images 914 and 915 are shot. In this case, when a slide show including the input images 911 to 915 as the input images of the reproduction target is reproduced, as shown in FIG. 59, the input images 911, 912, 913, 914 and 915 are sequentially reproduced in this order.

A method of reproducing a slide show according to similarity between a plurality of images is proposed.

It can be said that the input image 901 and the input image 904 of FIG. 56 are related to each other; it can be said that the input image 911 and the input images 912 and 913 of FIG. 58B are also related to each other. However, in the conventional slide show reproduction, the reproduction is performed with no consideration given to those relationships. Therefore, for example, the reproduction images as a whole are disadvantageously redundant. For example, in the slide show reproduction of FIG. 57, since the input image 901 and the input image 904 that is probably similar to the input image 901 are separately and independently reproduced, the details of the reproduction may be redundant.

### SUMMARY OF THE INVENTION

According to the present invention, there is provided a first image reproduction device including: a target image selection portion that selects, according to a selection operation, n sheets of target images from m sheets of input images (m and n are integers of two or more, and m>n), the selected n sheets of target images being sequentially displayed on a display screen such that slide show reproduction is performed; an image classification portion that classifies the m sheets of input images into a plurality of classes based on an image feature quantity extracted from each of the input images; and a display control portion that displays, when an input of the selection operation is received, the input images on the display screen in an arrangement based on a result of the classification of the image classification portion.

According to the present invention, there is provided a second image reproduction device including: a target image selection portion that selects, according to a selection operation, n sheets of target images from m sheets of input images (m and n are integers of two or more, and m>n), the selected n sheets of target images being sequentially displayed on a display screen such that slide show reproduction is performed, in which, when a predetermined operation is received while a p-th round of slide show reproduction is being performed, an input image that is not selected as one of the target images in the p-th round of slide show reproduction is displayed, and selection of target images in a (p+1)-th round of slide show reproduction or in rounds of slide show reproduction subsequent to the (p+1)-th round of slide show reproduction is received (p is a natural number).

According to the present invention, there is provided a first image reproduction method including: a target image selection step of selecting, according to a selection operation, n sheets of target images from m sheets of input images (m and n are integers of two or more, and m>n); a reproduction step of sequentially displaying the selected n sheets of target images on a display screen such that slide show reproduction is performed; an image classification step of classifying the m sheets of input images into a plurality of classes based on an image feature quantity extracted from each of the input images; and a display control step of displaying, when an input of the selection operation is received, the input images on the display screen in an arrangement based on a result of the classification of the image classification step.

According to the present invention, there is provided a second image reproduction method including: a target image selection step of selecting, according to a selection operation, n sheets of target images from m sheets of input images (m and n are integers of two or more, and m>n); a reproduction step of sequentially displaying the selected n sheets of target images on a display screen such that slide show reproduction is performed; and a selection reception step of displaying, when a predetermined operation is received while a p-th round of slide show reproduction is being performed, an input image that is not selected as one of the target images in the p-th round of slide show reproduction, and of receiving selection of target images in a (p+1)-th round of slide show reproduction or in rounds of slide show reproduction subsequent to the (p+1)-th round of slide show reproduction (p is a natural number).

According to the present invention, there is provided a third image reproduction device that reproduces a plurality of input images including first and second input images, the image reproduction device including: a reproduction control portion that performs slide show reproduction in which the plurality of input images are sequentially reproduced; and a link information processing portion that generates link information corresponding to a relationship between the first and second input images when the second input image is an image based on the first input image or when the first input image is a moving image and the second input image is a still image shot in a shooting time period of the first input image, in which the reproduction control portion performs, when the link information is present, the slide show reproduction based on the link information.

According to the present invention, there is provided a third image reproduction method that reproduces a plurality of input images including first and second input images, the image reproduction method including: a reproduction control step of performing slide show reproduction in which the plurality of input images are sequentially reproduced; and a link information processing step of generating link information corresponding to a relationship between the first and second input images when the second input image is an image based on the first input image or when the first input image is a moving image and the second input image is a still image shot in a shooting time period of the first input image, in which, in the reproduction control step, when the link information is present, the slide show reproduction is performed based on the link information.

### BRIEF DESCRIPTION OF THE DRAWINGS

FIG. 1 is a schematic overall block diagram of an image sensing device according to a first embodiment of the present invention;

FIG. 2 is an internal configuration diagram of an image sensing portion of FIG. 1;

FIG. 3 is a diagram showing the structure of an image file;

FIG. 4 is a diagram showing additional data that is stored in the header region of the image file;

FIG. 5 is a diagram showing m image files and m sheets of input images in the first embodiment of the present invention;

FIG. 6 is a block diagram of a portion that is particularly involved in the realization of slide show reproduction in the first embodiment of the present invention;

FIG. 7 is an internal block diagram of an image analysis portion of FIG. 6;

FIGS. 8A and 8B are respectively a diagram showing a feature space and a diagram showing a relationship between a plurality of feature vectors in the feature space, in the first embodiment of the present invention;

FIG. 9 is a diagram showing relationship degrees between a plurality of input images;

FIG. 10 is a diagram illustrating clustering processing in the first embodiment of the present invention;

FIG. 11 is a diagram showing how eight sheets of input images are classified into four classes in the first embodiment of the present invention;

FIG. 12 is a diagram showing how a plurality of class display regions and a plurality of element display regions are set on a display screen in the first embodiment of the present invention;

FIG. 13 is a diagram showing how one sheet of input image is displayed in one element display region in the first embodiment of the present invention;

FIG. 14 is a diagram showing how a check box is displayed together with an input image in the first embodiment of the present invention;

FIG. 15 is a diagram showing an example of the display screen in the first embodiment of the present invention;

FIGS. 16A and 16B are respectively a diagram showing an input image and a check box and a diagram showing a plurality of check states that can be taken by the check box, in the first embodiment of the present invention;

FIG. 17 is a diagram showing an example of the display screen in the first embodiment of the present invention;

FIG. 18 is a diagram showing an example of the display screen in the first embodiment of the present invention;

FIG. 19 is a diagram showing how eight sheets of input images are classified into five classes in the first embodiment of the present invention;

FIG. 20 is a diagram showing an example of the display screen in the first embodiment of the present invention;

FIGS. 21A and 21B are diagrams showing how the display screen is changed according to a user operation in the first embodiment of the present invention;

FIGS. 22A and 22B are diagrams showing how the display screen is changed according to a user operation in the first embodiment of the present invention;

FIG. 23 is a diagram showing a variation of the method of setting a plurality of class display regions on the display screen, in the first embodiment of the present invention;

FIG. 24 is a diagram showing a member that can be provided in an operation portion of FIG. 1;

FIGS. 25A and 25B are respectively a diagram showing an association icon and a diagram showing an example of the display method of the association icon, in a second embodiment of the present invention;

FIG. 26 is a diagram showing how an image displayed in a first specific example is changed, in the second embodiment of the present invention;

FIG. 27 is a diagram showing how an image displayed in a second specific example is changed, in the second embodiment of the present invention;

FIG. 28 is a diagram showing how an image displayed in a third specific example is changed, in the second embodiment of the present invention;

FIG. 29 is a diagram showing how an image displayed in a fourth specific example is changed, in the second embodiment of the present invention;

FIG. 30 is a diagram showing how an image displayed in a fifth specific example is changed, in the second embodiment of the present invention;

FIG. 31 is a diagram showing how an image displayed in a sixth specific example is changed, in the second embodiment of the present invention;

FIG. 32 is an internal block diagram of an electronic apparatus according to a variation of the present invention;

FIG. 33 is a diagram showing an example of the display screen of a conventional image reproduction device;

FIG. 34 is a diagram illustrating the details of additional data that can be stored in the header region of an image file, in a third embodiment of the present invention;

FIG. 35 is a block diagram of a portion that is involved in the realization of an image edition function and a slide show function, in the third embodiment of the present invention;

FIG. 36 is a diagram showing five input images and five image files in the third embodiment of the present invention;

FIG. 37 is a diagram showing the details of basic slide show reproduction in the third embodiment of the present invention;

FIGS. 38A to 38C are diagrams illustrating three link methods on the recording of link information in the third embodiment of the present invention;

FIG. 39 is an operational flowchart of a specific procedure of improved slide show reproduction in the third embodiment of the present invention;

FIGS. 40A and 40B are diagrams showing the contents of reproduction in the improved slide show reproduction in the third embodiment of the present invention;

FIG. 41 is a diagram showing the contents of another reproduction in the improved slide show reproduction in the third embodiment of the present invention;

FIGS. 42A and 42B are diagrams showing the contents of still another reproduction in the improved slide show reproduction in the third embodiment of the present invention;

FIG. 43 is a diagram showing the contents of still another reproduction in the improved slide show reproduction in the third embodiment of the present invention;

FIG. 44 is an operational flowchart of another specific procedure of the improved slide show reproduction in the third embodiment of the present invention;

FIG. 45 is an operational flowchart of still another specific procedure of the improved slide show reproduction in the third embodiment of the present invention;

FIGS. 46A and 46B are diagrams showing a plurality of image files of an application in the third embodiment of the present invention;

FIGS. 47A and 47B are respectively a diagram showing a shooting time relationship between a moving image and still images and a diagram showing five input images and five image files, in a fourth embodiment of the present invention;

FIG. 48 is a diagram showing the details of basic slide show reproduction in the fourth embodiment of the present invention;

FIGS. 49A to 49C are diagrams illustrating three link methods on the recording of link information in the fourth embodiment of the present invention;

FIG. 50 is a diagram showing the contents of reproduction in improved slide show reproduction in the fourth embodiment of the present invention;

FIG. 51 is a diagram showing the contents of another reproduction in the improved slide show reproduction in the fourth embodiment of the present invention;

FIGS. 52A and 52B are diagrams showing the contents of still another reproduction in the improved slide show reproduction in the fourth embodiment of the present invention;

FIGS. 53A and 53B are diagrams showing the contents of still another reproduction in the improved slide show reproduction in the fourth embodiment of the present invention;

FIGS. 54A and 54B are diagrams showing the contents of still another reproduction in the improved slide show reproduction in the fourth embodiment of the present invention;

FIG. 55 is an internal block diagram of an electronic apparatus according to the present invention;

FIG. 56 is a diagram illustrating a conventional technology and illustrating a time relationship between five input images;

FIG. 57 is a diagram showing the details of conventional slide show reproduction on the images of FIG. 56;

FIG. 58 is a diagram illustrating the conventional technology and illustrating a time relationship between five input images (one moving image and four still images); and

FIG. 59 is a diagram showing the details of the conventional slide show reproduction on the images of FIG. 58.

### DETAILED DESCRIPTION OF PREFERRED EMBODIMENTS

Examples of embodiments of the present invention will be specifically described below with reference to accompanying drawings. In the referenced drawings, like parts are identified with common symbols, and their description will not be basically repeated.

### First Embodiment

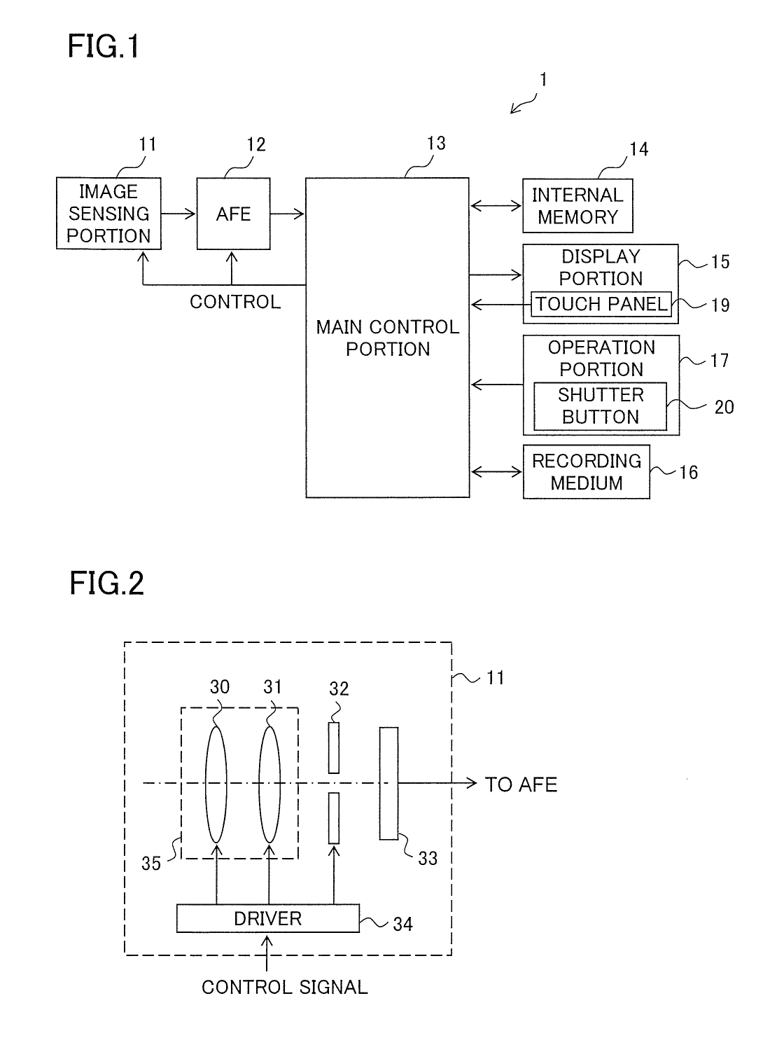

A first embodiment of the present invention will be described. FIG. 1 is a schematic overall block diagram of an image sensing device 1 according to the first embodiment. The image sensing device 1 is a digital video camera that can shoot and record a still image and a moving image. However, the image sensing device 1 may be a digital still camera that can shoot and record only a still image. The image sensing device 1 may be a device that is incorporated into a mobile terminal such as a mobile telephone.

The image sensing device 1 includes an image sensing portion 11, an AFE (analog front end) 12, a main control portion 13, an internal memory 14, a display portion 15, a recording medium 16 and an operation portion 17. The display portion 15 may be considered to be provided in an external device (not shown) of the image sensing device 1.

FIG. 2 shows an internal configuration diagram of the image sensing portion 11. The image sensing portion 11 includes an optical system 35, an aperture 32, an image sensor 33 that is formed with a CCD (charge coupled device), a CMOS (complementary metal oxide semiconductor) image sensor or the like and a driver 34 for driving and controlling the optical system 35 and the aperture 32. The optical system 35 is formed with a plurality of lenses including a zoom lens 30 and a focus lens 31. The zoom lens 30 and the focus lens 31 can be moved in the direction of an optical axis. Based on a control signal from the main control portion 13, the driver 34 drives and controls the positions of the zoom lens 30 and the focus lens 31 and the degree of opening of the aperture 32, and thereby controls the focal length (the angle of view) and the focal position of the image sensing portion 11 and the amount of light entering the image sensor 33 (in other words, an aperture value).

The image sensor 33 photoelectrically converts an optical image that enters the image sensor 33 through the optical system 35 and the aperture 32 and that indicates a subject, and outputs, to the AFE 12, an electrical signal obtained by performing the photoelectrical conversion. Specifically, the image sensor 33 has a plurality of light-receiving pixels that are two-dimensionally arranged in a matrix, and each of the light-receiving pixels stores, in each round of shooting, the signal charge of a charge amount corresponding to an exposure time. Analog signals from the light-receiving pixels having a size proportional to the charge amount of the stored signal charge are sequentially output to the AFE 12 according to a drive pulse produced within the image sensing device 1.

The AFE 12 amplifies the analog signal output from the image sensing portion 11 (the image sensor 33), and converts the amplified analog signal into a digital signal. The AFE 12 outputs this digital signal as RAW data to the main control portion 13. The amplification degree of a signal in the AFE 12 is controlled by the main control portion 13.

The main control portion 13 is formed with a CPU (central processing unit), a ROM (read only memory), a RAM (random access memory) and the like. Based on the RAW data from the AFE 12, the main control portion 13 generates image data indicating an image (hereinafter also referred to as a shooting image) shot by the image sensing portion 11. The image data generated here includes, for example, a brightness signal and a color-difference signal. The RAW data itself is one type of image data; the analog signal output from the image sensing portion 11 is also one type of image data. The main control portion 13 also functions as a display control portion that controls the details of a display on the display portion 15, and performs control necessary for the display on the display portion 15.

The internal memory 14 is formed with a SDRAM (synchronous dynamic random access memory) or the like, and temporarily stores various types of data generated within the image sensing device 1.

The display portion 15 is a display device that has a display screen such as a liquid crystal display panel, and displays, under control of the main control portion 13, a shot image and an image and the like recorded in the recording medium 16. When, in the present specification, “display” and “display screen” are simply mentioned, they refer to the display and the display screen on the display portion 15. The display portion 15 is provided with a touch panel 19; the user touches the display screen of the display portion 15 with an operation member (such as a finger or a touch pen), and can thereby provide a specific instruction to the image sensing device 1. The touch panel 19 can be omitted.

The recording medium 16 is a nonvolatile memory such as a card semiconductor memory or a magnetic disc, and records, under control of the main control portion 13, image data on the shooting image and the like. The operation portion 17 includes a shutter button 20 or the like that receives an instruction to shoot a still image, and receives various types of operations from the outside. The details of the operation performed on the operation portion 17 are transmitted to the main control portion 13.

The image sensing device 1 has a slide show function to sequentially reproduce a plurality of input images on the display portion 15. In the slide show function, the input images are sequentially displayed on the display screen of the display portion 15; this type of sequential display is referred to as the slide show reproduction. The input image refers to an arbitrary still image or moving image. Here, it is assumed that the input image is a still image or moving image shot by the image sensing device 1, and that image data on the input image is recorded in the recording medium 16. When image data is recorded in the recording medium 16, the image data may be compressed. For ease of description, a description will be given below regardless of whether or not the image data is compressed.

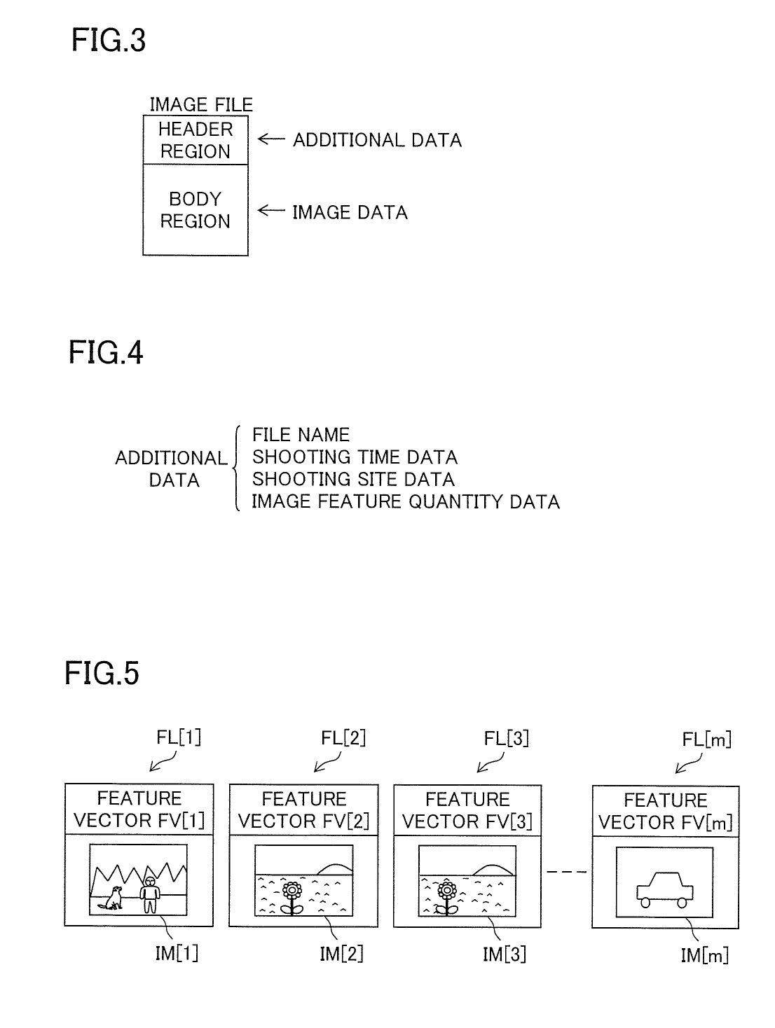

The image data on the input image is stored in the image file, and then can be recorded in the recording medium 16. FIG. 3 shows the structure of an image file. One image file can be produced for one still image or one moving image. The structure of the image file can be made to conform to an arbitrary standard. The image file is formed with a body region where image data on a still image or a moving image is stored and a header region where additional data is stored.

As shown in FIG. 4, in the additional data to an image file, a file name that is the own name of such an image file, shooting time data that indicates the shooting time of an input image corresponding to the image file, shooting site data that indicates the shooting site of the input image corresponding to the image file, image feature quantity data on the input image corresponding to the image file and the like can be included. When an input image is a moving image, the shooting time of the input image is assumed to be, for example, the shooting start time of the moving image as the input image.

The reproduction of a still image in the slide show reproduction refers to the display of the still image only for a predetermined time period. The reproduction of a moving image in the slide show reproduction refers to the display of all sections or a partial section of the moving image. The partial section may be one frame section. In this case, when the moving image is reproduced in the slide show reproduction, only a typical frame (for example, the first frame) among a plurality of frames that form the moving image is displayed only for a predetermined time period. In the following description, unless particularly otherwise specified, the input image is assumed to be a still image.

FIG. 5 shows m image files FL[1] to FL[m] that are recorded in the recording medium 16. Here, m is an integer of two or more. Image data on an input image IM[i] is stored in an image file FL[i] (i is an arbitrary integer). Specifically, image data on input images IM[1] to IM[m] is stored in the image files FL[1] to FL[m], respectively. In the header region of the image file FL[i], additional data to the input image IM[i] is stored. A feature vector FV[i] shown in FIG. 5 will be described later.

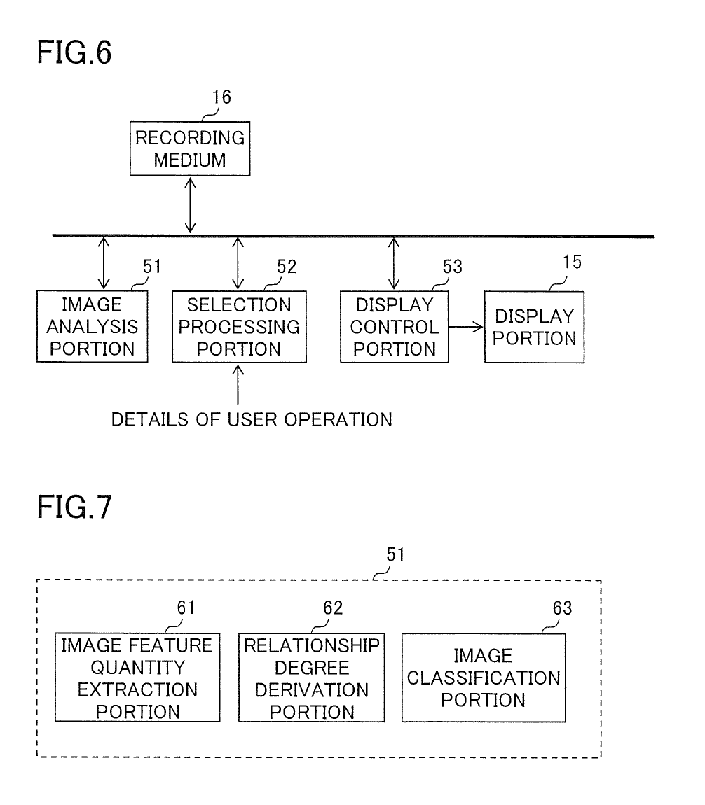

FIG. 6 shows a block diagram of a portion that is particularly involved in the realization of the slide show function. An image analysis portion 51, a selection processing portion 52 and a display control portion 53 can be provided in, for example, the main control portion 13 of FIG. 1. FIG. 7 is an internal block diagram of the image analysis portion 51. Portions represented by symbols 61 to 63 are provided in the image analysis portion 51. The image analysis portion 51, the selection processing portion 52 and the display control portion 53 can freely read all data recorded in the recording medium 16.

Based on image data on an input image that is fed from the recording medium 16 or image data on an input image that is fed without intervention of the recording medium 16, the image analysis portion 51 analyzes the details of the input image. This analysis includes image feature quantity extraction processing that is performed by the image feature quantity extraction portion 61. In the mage feature quantity extraction processing, the image feature quantity extraction portion 61 extracts the image feature quantity of the input image from the image data on the input image. The image feature quantity of the input image is a quantity that depends on the image feature of the input image, that is, a quantity that depends on the shape, the color, the texture and the like of an object present on the input image; here, a feature vector is assumed to be derived as the image feature quantity of the input image. As the method of deriving the image feature quantity or the feature vector, an arbitrary method including a known method (for example, the method disclosed in JP-A-2009-134411) can be utilized. For example, a method defined in MPEG (moving picture experts group) 7 is applied to the input image, and thus it is possible to derive the feature vector of the input image.

The derivation of the feature vector can be performed on each input image. The feature vector derived from the input image IM[i] is represented by FV[i]. As shown in FIG. 5, the image feature quantity data indicating the feature vector FV[i] can be stored in the header region of the image file FL[i].

The relationship degree derivation portion 62 performs similarity evaluation processing for evaluating the similarity of the image feature between two arbitrary input images, and derives the relationship degree of the two input images based on the result of the similarity evaluation processing. It may be considered that a similarity evaluation portion (not shown) which performs the similarity evaluation processing is included in the relationship degree derivation portion 62.

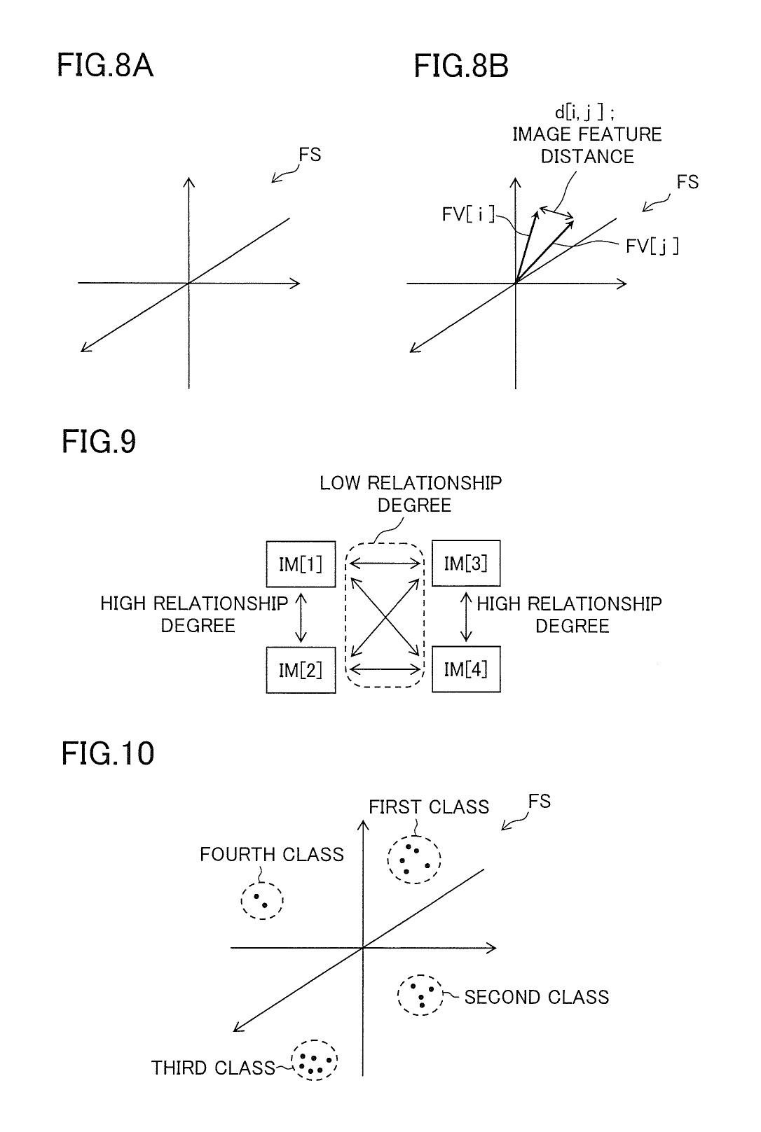

The similarity evaluation processing performed on two different input images IM[i] and IM[j] will be described (i and j are integers; i≠j). The feature vector is a vector quantity that needs to be arranged in the feature space FS of a plurality of dimensions as shown in FIG. 8A. Although, in FIG. 8A, the feature space FS is shown as if it is a three-dimensional space, the number of dimensions of the feature space FS may be a number other than three. The approximation of the feature vector FV[i] to a feature vector FV[j] in the feature space FS means that the image feature of the input image IM[i] is approximate to the image feature of the input image IM[j]. Hence, in the similarity evaluation processing on the input images IM[i] and IM[j], as shown in FIG. 8B, the end point of the feature vector FV[i] and the end point of the feature vector FV[j] in the feature space FS are plotted in the feature space FS, and the distance (Euclidean distance) d[i, j] between the end points are determined. The distance d[i, j] is also referred to as an image feature distance between two input images. Then, if the distance d[i, j] is less than a predetermined reference distance d_{REF}, the similarity in the image feature between the input images IM[i] and IM[j] is determined to be high whereas, if the distance d[i, j] is equal to or more than the reference distance d_{REF}, the similarity in the image feature between the input images IM[i] and IM[j] is determined to be low. The relationship degree derivation portion 62 can perform the similarity evaluation processing on a combination of two arbitrary input images. The start point of an arbitrary feature vector including the feature vectors FV[i] and FV[j] is arranged at the origin of the feature space FS.

Based on the result of the similarity evaluation processing performed on input images IM[i] and IM[j], the relationship degree derivation portion 62 can determine the relationship degree between the input images IM[i] and IM[j]. Simply, for example, the degree of the similarity itself can be utilized as the relationship degree. Specifically, for example, if the similarity on the image feature between the input images IM[i] and IM[j] is determined to be high, the relationship degree between the input images IM[i] and IM[j] is determined to be high whereas, if the similarity on the image feature between the input images IM[i] and IM[j] is determined to be low, the relationship degree between the input images IM[i] and IM[j] can be determined to be low.

The relationship degree may be determined by adding other information to the result of the similarity evaluation processing. The other information refers to, for example, the shooting time data and the shooting site data (see FIG. 4).

Specifically, for example, even when the distance d[i, j] is less than the reference distance d_{REF}, if an inequality “d[i, j]+Δd>d_{REF}” holds true (Δd has a predetermined positive value) and the shooting time difference between the input images IM[i] and IM[j] is equal to or more than a predetermined reference time difference, the relationship degree between the input images IM[i] and IM[j] may be determined to be low. By contrast, even when the distance d[i, j] is equal to or more than the reference distance d_{REF}, if an inequality “d[i, j]−Δd<d_{REF}” holds true and the shooting time difference between the input images IM[i] and IM[j] is less than the predetermined reference time difference, the relationship degree between the input images IM[i] and IM[j] may be determined to be high.

Likewise, for example, even when the distance d[i, j] is less than the reference distance d_{REF}, if the inequality “d[i, j]+Δd>d_{REF}” holds true (Δd has a predetermined positive value) and the distance difference between the shooting sites of the input images IM[i] and IM[j] is equal to or more than a predetermined reference distance difference, the relationship degree between the input images IM[i] and IM[j] may be determined to be low. By contrast, even when the distance d[i, j] is equal to or more than the reference distance d_{REF}, if the inequality “d[i, j]−Δd<d_{REF}” holds true and the distance difference between the shooting sites of the input images IM[i] and IM[j] is less than the predetermined reference distance difference, the relationship degree between the input images IM[i] and IM[j] may be determined to be high.

Although, in the method of deriving the relationship degree described above, the relationship degree is evaluated in two steps (specifically, whether the relationship degree is high or low is determined), the relationship degree may be classified into three steps or more.

The image classification portion 63 of FIG. 7 classifies m sheets of input images into a plurality of classes based on the relationship degrees derived by the relationship degree derivation portion 62. In this case, a collection of input images whose relationship degrees are determined to be high preferably forms one class, and input images whose relationship degrees are determined to be low are preferably classified into different classes. For convenience, the relationship degree between the input images IM[i] and IM[j] is represented by a symbol RD[i, j]. For example, as shown in FIG. 9, when the relationship degrees RD[1, 2] and RD[3, 4] are high, and the relationship degrees RD[1, 3], RD[1, 4], RD[2, 3] and RD [2, 4] are low, the input images IM[1] and IM[2] can be classified into the first class, and the input images IM[3] and IM[4] can be classified into the second class. When i and j are different integers, the i-th class and the j-th class are different classes.

In a case where the relationship degrees RD[1, 2] and RD[3, 4] are high, when any one or more of the relationship degrees RD[1, 3], RD[1, 4], RD[2, 3] and RD [2, 4] are high, the input images IM[1] to IM[4] may be classified into a common class. Alternatively, in a case where the relationship degrees RD[1, 2] and RD[3, 4] are high, only when any two or three or more of the relationship degrees RD[1, 3], RD[1, 4], RD[2, 3] and RD [2, 4] are high, the input images IM[1] to IM[4] may be classified into a common class.

Since the relationship degree is determined based on the image feature quantity, the classification based on the relationship degree is equivalent to the classification based on the image feature quantity. The classification may not be performed through the relationship degree, and the classification may be directly performed based on the feature vector.

In the classification of the input images based on the feature vectors of the input images, clustering processing can be used. Since the method of performing the clustering processing is known, one example of the method will be simply described here. For example, as shown in FIG. 10, the end points of the feature vectors FV[1] to FV[m] in the feature space FS are plotted in the feature space FS, and the end points are preferably classified such that, based on the positions of the end points in the feature space FS, the end points which are close to each other in the feature space FS are classified into a common class and that the end points which are not close to each other in the feature space FS are classified into different classes. The classification of the end point of the feature vector FV[i] into the first class means the classification of the input image IM[1] into the first class; the classification of the end point of the feature vector FV[i] into the second class means the classification of the input image IM[1] into the second class.

The selection processing portion 52 of FIG. 6 functions as a target image selection portion, and selects, according to a selection operation performed by the user, n sheets of input images from m sheets of input images IM[1] to IM[m] as target images. The selection operation is performed on the operation portion 17 or the touch panel 19. Here, n is an integer of two or more where an inequality “m>n” holds true. Input image that are not selected as the target images from the input images IM[1] to IM[m] are particularly referred to as non-target images. The number of non-target images may be one.

The display control portion 53 controls the details of a display on the display portion 15; the display control portion 53 controls the display portion 15 such that, in the slide show reproduction, n sheets of target images are sequentially displayed on the display screen at given time intervals. In the present embodiment, the reproduction of the image is synonymous with the display of the image. The non-target images are not reproduced while the slide show is being reproduced. Specifically, for example, when the input images IM[1], IM[2] and IM[5] are set at the target images, and the input images IM[3] and IM[4] are set at the non-target images, in the slide show reproduction, the input images IM[3] and IM[4] are not displayed at all, and the input images IM[1], IM[2] and IM[5] are sequentially displayed at given time intervals (in other words, the reproduction time period of each of the input images IM[3] and IM[4] is set at zero).

However, in the slide show reproduction, the non-target image may be reproduced only for a short time period. In other words, in the slide show reproduction, not only the target images may be sequentially reproduced but also the non-target image may be reproduced only for a reproduction time period shorter than the reproduction time period of the target image. In this case, the selection operation can be said to be an operation of setting the reproduction time period of each of the input images. Specifically, for example, when the input images IM[1], IM[2] and IM[5] are set at the target images, and the input images IM[3] and IM[4] are set at the non-target images, in the slide show reproduction, while or after the input images IM[1], IM[2] and IM[5] are sequentially displayed at given time intervals, the input images IM[3] and IM[4] each may be displayed only for a time period tₛ. The time period tₛ (for example, 0.5 second) is shorter than the reproduction time period t_{L} (for example, three seconds) of each of the input images IM[1], IM[2] and IM[5] that are the target images. The reproduction time period is synonymous with the display time period.

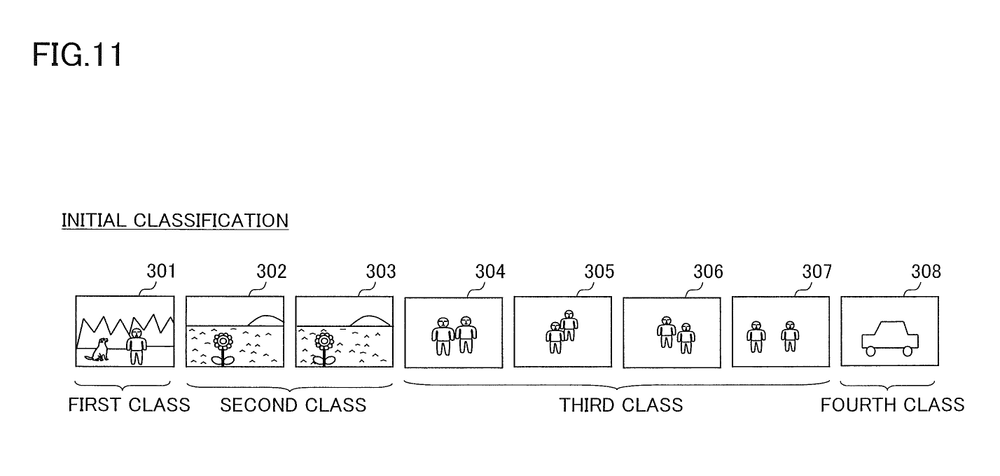

Before the slide show reproduction is performed, the operation mode of the image sensing device 1 can be set at a target image selection mode for selection of the target image. In the first embodiment, the operation of the image sensing device 1 in the target image selection mode will be described below. In the following description, a case where input images 301 to 308 shown in FIG. 11 are included in the input images IM[1] to IM[m] is considered, and, unless otherwise particularly specified, no input images are assumed to be present except the input images 301 to 308 (the same is true in a second embodiment, which will be described later). It is assumed that, based on the image feature quantity of the input images 301 to 308, the image analysis portion 51 classifies the input image 301 into the first class, the input images 302 and 303 into the second class, the input images 304 to 307 into the third class and the input image 308 into the fourth class.

The above classification of the input images 301 to 308 shown in FIG. 11 is referred to as an initial classification. The classification in the initial classification can be changed thereafter (its details will be described later).

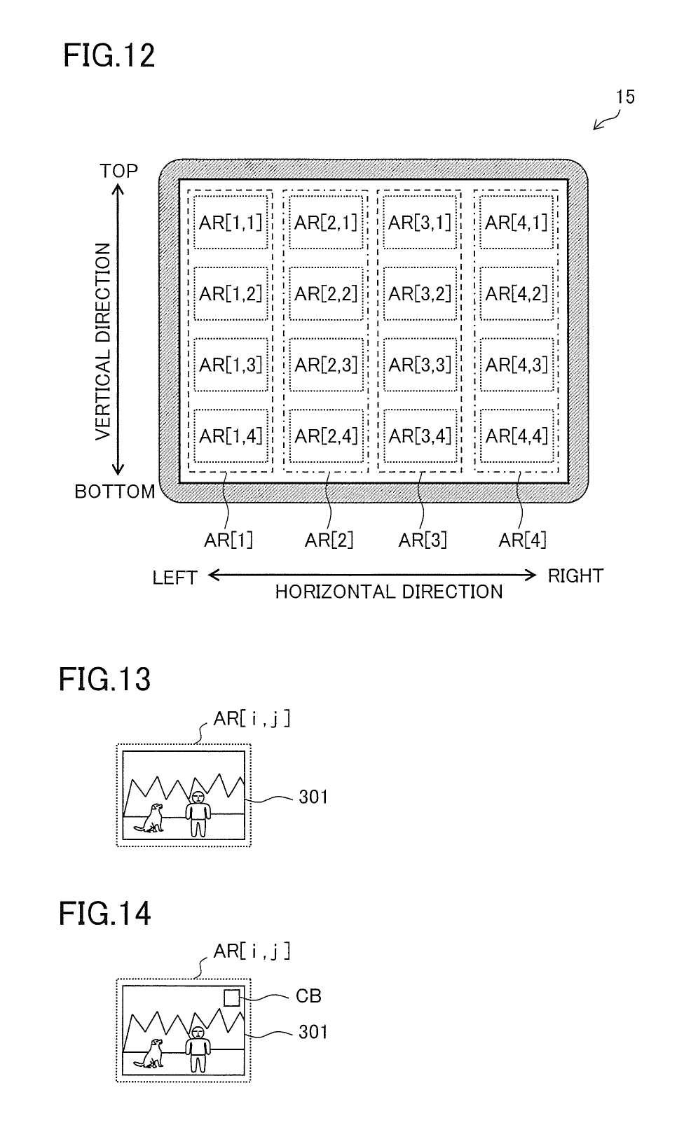

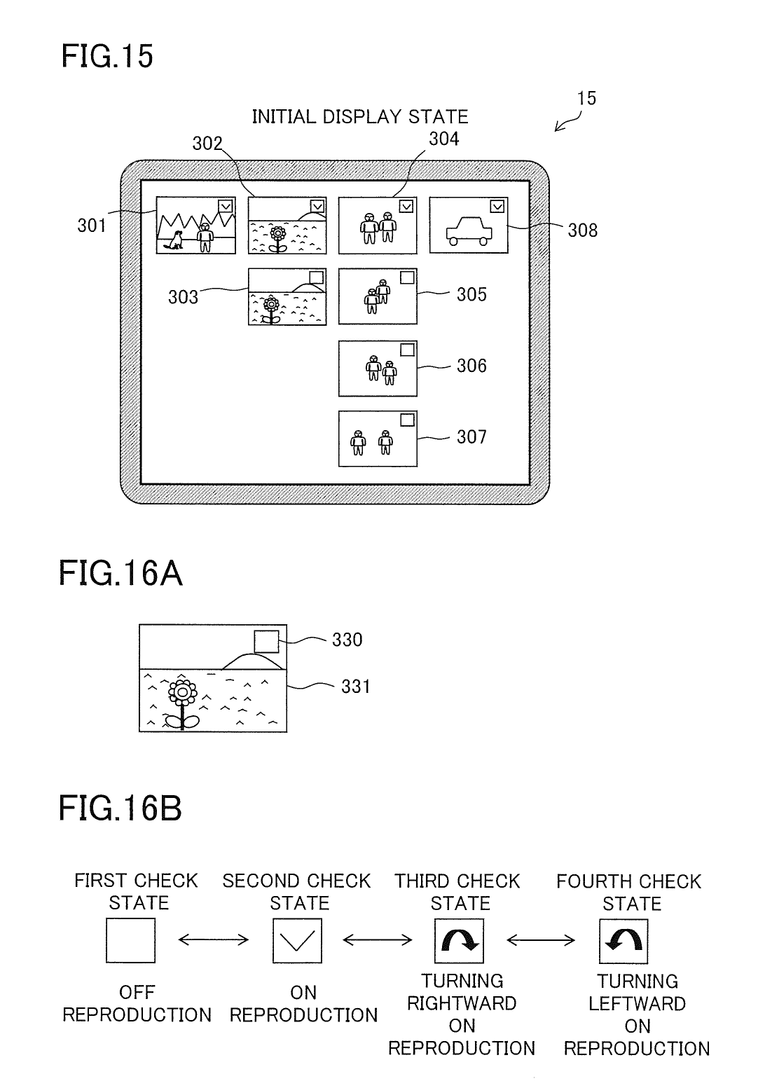

In the target image selection mode, the display control portion 53 divides the entire display region of the display screen of the display portion 15 into a plurality of pieces, and thereby sets a plurality of class display regions in the display screen. Here, four class display regions are assumed to be set in the display screen. Specifically, as shown in FIG. 12, the entire display region of the display screen is divided into four class display regions AR[1] to AR[4] by three boundaries parallel to the vertical direction of the display screen, and one class is allocated to one class display region. Which class is allocated to which class display region is freely determined; however, different classes are allocated to different class display regions. In figures (FIG. 12, FIG. 15 to be described later and the like) showing the state of the display portion 15, a diagonally shaded region represents a display portion enclosure surrounding the display screen.

Each of the class display regions is further subdivided into a plurality of element display regions. Here, four element display regions are assumed to be provided in each of the class display regions; as shown in FIG. 12, four element display regions provided in a class display region AR[i] are represented by symbols AR[i, 1] to AR[i, 4]. On the display screen, the vertical direction corresponds to an up and down direction, and the horizontal direction corresponds to a left and right direction. It is assumed that the left, right, top and bottom seen from the user opposite the display screen coincide with the left, right, top and bottom of the display screen. In the following description, the class display region AR[i] and the element display region AR[i, j] may be referred to as a region AR[i] and a region AR[i, j], respectively, for short.

In the class display region AR[i], the regions AR[i, 1], AR[i, 2], AR[i, 3] and AR[i, 4] are arranged in this order from top to bottom. The regions AR[1, j], AR[2, j], AR[3, j] and AR[4, j] are arranged in this order along the horizontal direction from left to right.

As shown in FIG. 13, one sheet of input image can be displayed in one element display region. When an input image is displayed, resolution conversion corresponding to the display size of the input image may be performed on image data on the input image. FIG. 13 shows a state where the input image 301 is displayed in the element display region AR[i, j].

The display control portion 53 can be provided with a check box in each element display region where an input image is displayed (in other words, in each input image displayed). In FIG. 14, a rectangular frame CB represents a check box in the element display region AR[i, j] where the input image 301 is displayed. As shown in FIG. 14, the check box CB is superimposed and displayed on the input image. The check box CB may be displayed outside the corresponding input image.

In the target image selection mode, the display control portion 53 first allocates the first to fourth classes to the class display regions AR[1] to AR[4], respectively, and displays, in the class display region AR[i], an input image belonging to the i-th class. When, in this state, a predetermined scrolling operation is performed, the second to fifth classes can be allocated to the class display regions AR[1] to AR[4], respectively, and an input image belonging to the (i+1)-th class can be displayed in the class display region AR[i]. Here, however, it is assumed that the first to fourth classes are allocated to the class display regions AR[1] to AR[4].

It is now assumed that one sheet of target image is set for each of the classes. Specifically, for example, it is assumed that the input images 301, 302, 304 and 308 are set at target images and the input images 303, 305 to 307 are set at non-target images, and that this state is an initial display state. FIG. 15 shows a state of the display screen in the initial display state.

Since, as described above, the first to fourth classes are allocated to the class display regions AR[1] to AR[4], respectively, in the display screen of FIG. 15, the input image 301 belonging to the first class is displayed using one element display region in the class display region AR[1], the input images 302 and 303 belonging to the second class are displayed using two element display regions in the class display region AR[2], the input images 304 to 307 belonging to the third class are displayed using four element display regions in the class display region AR[3] and the input image 308 belonging to the fourth class is displayed using one element display region in the class display region AR[4].

The display control portion 53 displays input images such that the target images are displayed in the element display regions AR[1, 1], AR[2, 1], AR[3, 1] and AR[4, 1] arranged in the uppermost step of the display screen. The rule that the target images are always displayed in the element display regions AR[1, 1], AR[2, 1], AR[3, 1] and AR[4, 1], that is, the rule that the target images are not displayed in element display regions other than the element display regions AR[1, 1], AR[2, 1], AR[3, 1] and AR[4, 1] is referred to as a rule a for convenience. In the display screen of FIG. 15, the input images 301, 302, 304 and 308 are displayed according to the rule α in the regions AR[1, 1], AR[2, 1], AR[3, 1] and AR[4, 1], respectively. In the initial display state, the input image 303 is displayed in the region AR[2, 2]. In the initial display state, the display positions of the input images 305 to 307 are freely determined as long as they are in the class display region AR[3]. For example, the input images 305, 306 and 307 can be arranged in order of shooting time. Here, the input images 305, 306 and 307 are assumed to be displayed in the regions AR[3, 2], AR[3, 3] and AR[3, 4], respectively.

The user specifies an arbitrary input image displayed on the display screen, and then can variously change the state of the check box corresponding to the specified input image. The user uses the operation portion 17 or the touch panel 19, and thereby can provide an instruction to specify the input image and an instruction to change the state of the check box. Alternatively, it is possible to directly and variously change the state of an arbitrary check box without the intervention of the specification of the input image. For convenience, the state of the check box is also referred to as a check state. The first to fourth check states that the check box 330 of FIG. 16A can take are shown in FIG. 16B. For convenience, the input image corresponding to the check box 330 is referred to as an input image 331.

The first check state is a state that corresponds to off reproduction; when the state of the check box 330 is the first check state, the input image 331 is set at a non-target image. The second to fourth check states are states that correspond to on reproduction; when the state of the check box 330 is the second, third or fourth check state, the input image 331 is set at target image.

In a case where the state of the check box 330 is the third check state, when the slide show reproduction is started, the input image 331 that is the target image is turned 90 degrees in the rightward direction and is displayed. In a case where the state of the check box 330 is the fourth check state, when the slide show reproduction is started, the input image 331 that is the target image is turned 90 degrees in the leftward direction and is displayed. The turning of the input image 331 is realized by know geometrical conversion. In a case where the state of the check box 330 is the second check state, when the slide show reproduction is started, the input image 331 that is the target image is displayed as it is without being turned as described above.

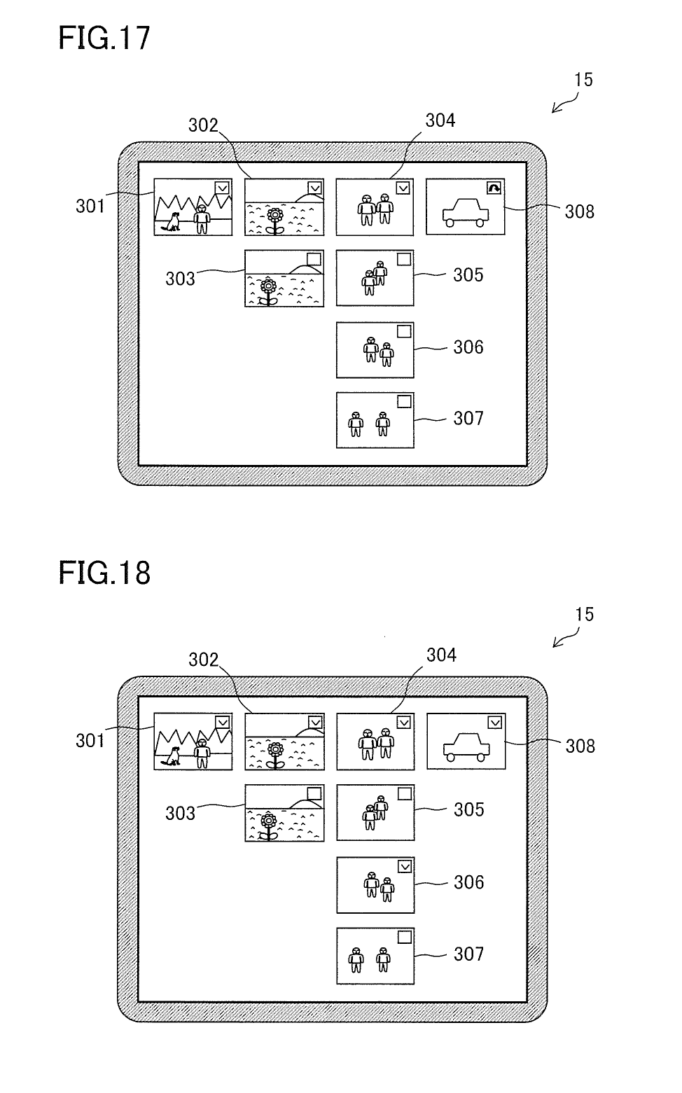

For example, in a state where the display of FIG. 15 is produced, when the check box corresponding to the input image 308 is specified with a cursor or the like on the display screen, and a predetermined operation is performed, the state of the check box corresponding to the input image 308 is changed from the second check state to the third check state, and the state of the display screen is changed from FIG. 15 to FIG. 17.

Now, consider a case where, with the initial display state of FIG. 15 being the starting point, the user changes the state of the check box of the input image 306 from the first check state to the second check state. FIG. 18 shows a state of the display screen immediately after this change is performed. In FIG. 18, in addition to the input images 301, 302, 304 and 308, the state of the check box of the input image 306 is also the second check state.

Until any operation is further provided by the user, the display control portion 53 can also maintain the display shown in FIG. 18. However, when a plurality of target images are set at a common class, the image classification portion 63 of FIG. 7 can reclassify input images belonging to this class into a plurality of classes, and the display control portion 53 can reflect the result of the reclassification on the display screen.

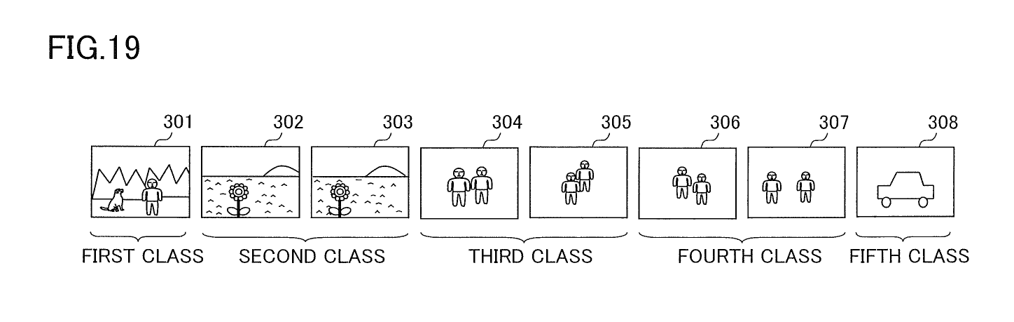

A reclassification method when, as shown in FIG. 18, the input image 306 is also set at the target image in addition to the input images 301, 302, 304 and 308 will be described (see FIG. 19). In this case, since two sheets of target images (304 and 306) are present in the third class, while the image analysis portion 51 maintains the classification of the input image 304 into the third class, the image analysis portion 51 changes the current fourth class to the fifth class (specifically, changes the class to which the input image 308 belongs to the fifth class) and then newly classifies the input image 306 into the fourth class. Then, the remaining input images 305 and 307 belonging to the third class are reclassified into any one of the third and fourth classes. Here, it is assumed that this reclassification is performed and thus, as shown in FIG. 19, the input image 305 is classified into the third class and the input image 307 is classified into the fourth class.

The image classification portion 63 can perform the reclassification of the input image 305 based on the feature vector. In this case, based on the feature vectors of the input images 304, 305 and 306, to which of the input images 304 and 306 the input image 305 is more similar is evaluated, and, if the input image 305 is evaluated to be more similar to the input image 304 among the input images 304 and 306, the input image 305 is preferably reclassified into the third class to which the input image 304 belongs. By contrast, if the input image 305 is evaluated to be more similar to the input image 306 among the input images 304 and 306, the input image 305 is preferably reclassified into the fourth class to which the input image 306 belongs. If, in the feature space FS (see FIG. 8B), the image feature distance between the input images 304 and 305 is shorter than that between the input images 305 and 306, the input image 305 can be evaluated to be more similar to the input image 304 whereas, if the image feature distance between the input images 304 and 305 is longer than that between the input images 305 and 306, the input image 305 can be evaluated to be more similar to the input image 306. Likewise, the reclassification of the input image 307 can be performed.

The image classification portion 63 can also perform reclassification based on the shooting times of the input images 304 to 307. Specifically, for example, when the input images 304, 305, 306 and 307 are shot in this order, the input image 305 that is a non-target image is classified into the class of a target image shot before the input image 305 among the input images 304 and 306 that are target images, and the input image 307 that is a non-target image is classified into the class of a target image shot before the input image 307 among the input images 304 and 306 that are target images. Since both the input image 304 and the input image 306 are target images shot before the input image 307, in this case, the input image 307 is preferably classified into the class of a target image shot at a time closer to the shooting time of the input image 307, that is, into the fourth class to which the input image 306 belongs (see FIG. 19). If the shooting time difference between the input image 305 and the input image 304 is compared with the shooting time difference between the input image 305 and the input image 306, and the former is shorter than the latter, the input image 305 may be reclassified into the third class to which the input image 304 belongs whereas, if the latter is shorter than the former, the input image 305 may be reclassified into the fourth class to which the input image 306 belongs. The same is true of the reclassification of the input image 307

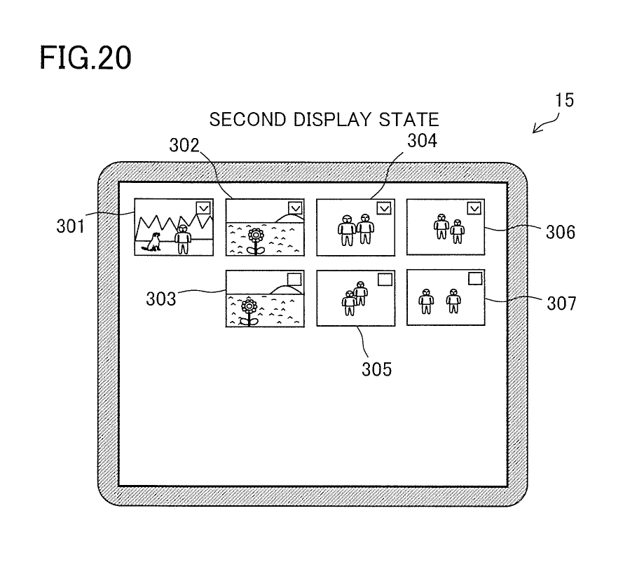

When, as shown in FIG. 19, the input images 304 and 305 are reclassified into the third class and the input images 306 and 307 are reclassified into the fourth class, the display control portion 53 allocates the first to fourth classes after the reclassification to the class display regions AR[1] to AR[4], respectively, and changes the details of the display according to the rule α. The state of the display screen after this change is shown in FIG. 20. For convenience, the state of the display screen of FIG. 20 is referred to as the second display state. Since the rule α is applied, in the display screen of FIG. 20, the input images 301, 302, 304 and 306 are displayed in the regions AR[1, 1], AR[2, 1], AR[3, 1] and AR[4, 1], respectively. Since the input images 303, 305 and 307 belong to the second, third and fourth classes after the reclassification, respectively (see FIG. 19), in the second display state, the input images 303, 305 and 307 are displayed in the regions AR[2, 2], AR[3, 2] and AR[4, 2], respectively.

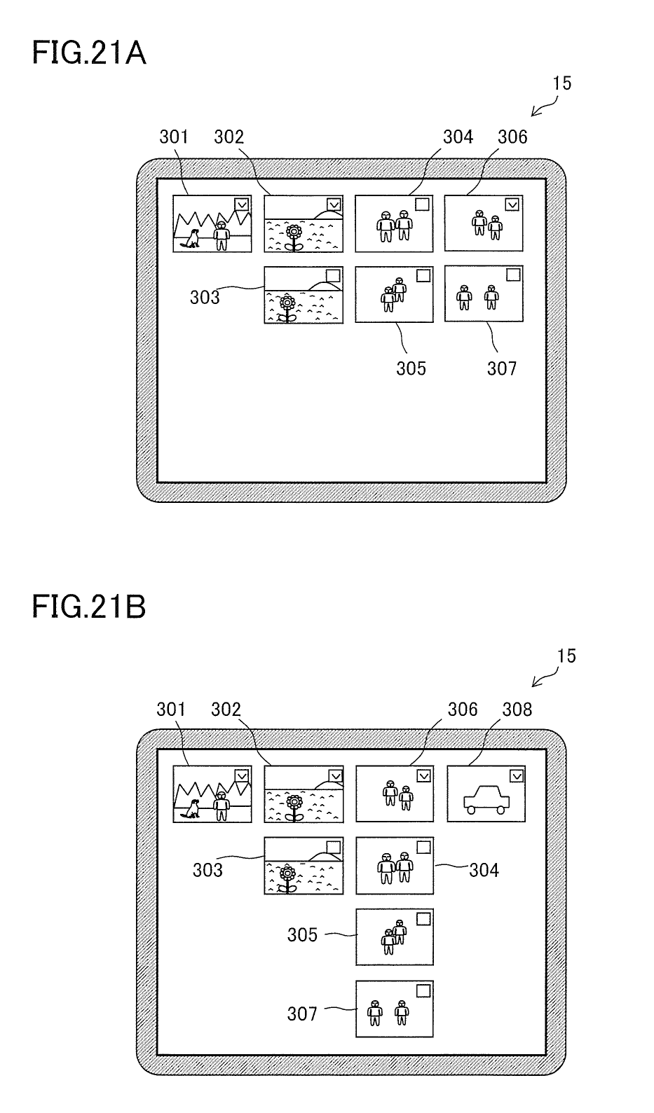

If, with the second display state being the starting point, the user performs an operation of changing the input image 306 from the target image to the non-target image (that is, the user performs an operation of changing the state of the check box corresponding to the input image 306 from the second check state to the first check state), the third class and the fourth class shown in FIG. 19 are integrated into one class (the third class), and the state of the display screen returns to the initial display state. If, with the second display state being the starting point, as shown in FIG. 21A, the user performs an operation of changing the input image 304 from the target image to the non-target image, the third class and the fourth class shown in FIG. 19 are also integrated into one class (the third class). However, in this case, since the target image belonging to the third class after the integration becomes the input image 306, as shown in FIG. 21B, the input images 301, 302, 306 and 308 are displayed in the regions AR[1, 1], AR[2, 1], AR[3, 1] and AR[4, 1], respectively, and the input images 304, 305 and 307 are displayed using the regions AR[3, 2] to AR[3, 4].

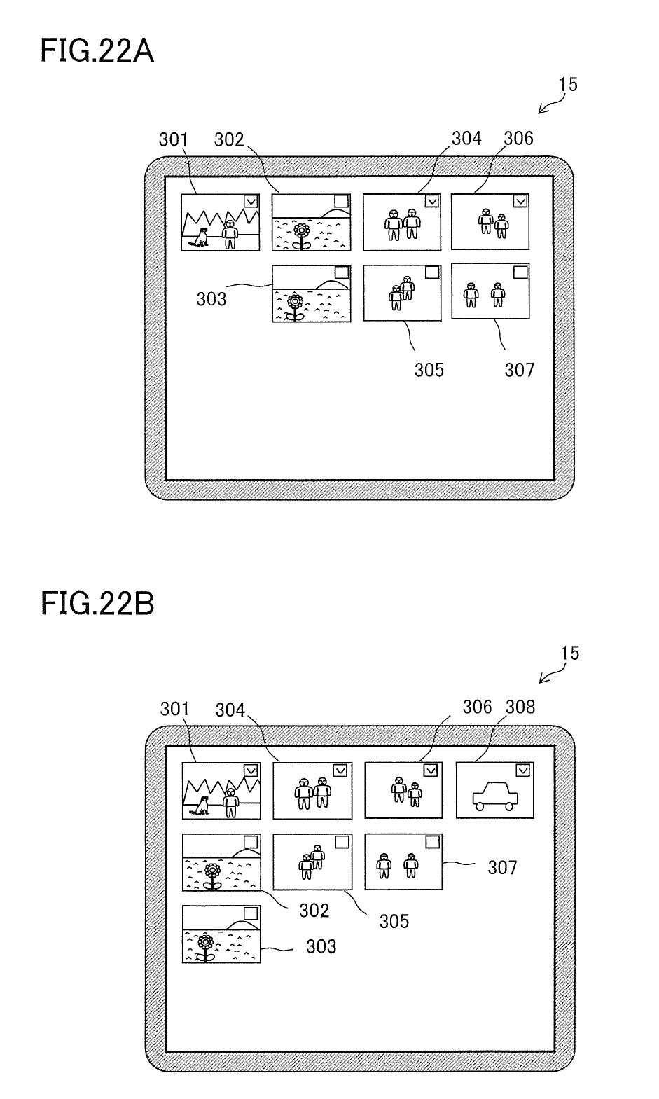

If, with the second display state being the starting point, as shown in FIG. 22A, the user performs an operation of changing the input image 302 from the target image to the non-target image (that is, the user performs an operation of changing the state of the check box corresponding to the input image 302 from the second check state to the first check state), the second class shown in FIG. 19 is integrated into another class, and, accordingly, the third to fifth classes of FIG. 19 are changed to the second to fourth classes, respectively. Here, it is assumed that the second class shown in FIG. 19 is integrated into the first class, and this integration causes the input images 302 and 303 to be reclassified into the first class. The rule α is also applied to the display after this reclassification. Consequently, as shown in FIG. 22B, the input images 301, 304, 306 and 308 that are target images are displayed in the regions AR[1, 1], AR[2, 1], AR[3, 1] and AR[4, 1], respectively, and the input images 302 and 303 that are non-target images are displayed in the regions AR[1, 2] and AR[1, 3], respectively.

In the first embodiment, a plurality of input images are classified into a plurality of classes according to similarity between the input images, and input images similar to each other are collected in a common class display region and are displayed. Therefore, the user can intuitively and instantaneously recognize, from the display positions of the input images, a similarity relationship between a plurality of input images, and easily performs an operation of selecting only desired input images as the target images from input images similar to each other.

When the rule α is applied, since the target images are always arranged and displayed in the uppermost step of the display screen, the user can instantaneously confirm what input images are set at the target images.

It is not mandatory to obey the rule α. When, with the second display state corresponding to FIG. 20 being the starting point, as shown in FIG. 22A, an operation of changing the input image 302 from the target image to the non-target image is performed, the classification shown in FIG. 19 may be maintained, and the details of the display may be kept in the state of FIG. 22A. In the state of FIG. 22A, the input images 301, 304 and 306 that are target images are displayed in the regions AR[1, 1], AR[3, 1] and AR[4, 1], respectively, and the input images 302, 303, 305 and 307 that are non-target images are displayed in the regions AR[2, 1], AR[2, 2], AR[3, 2] and AR[4, 2], respectively.

Although, in the method described above, the operation of changing the state of the check box corresponds to the selection operation for selecting target images, the specific method of the selection operation can be variously changed.

When the rule α is applied, a plurality of target images are arranged and displayed in the element display regions AR[1, 1], AR[2, 1], AR[3, 1] and AR[4, 1] positioned in the uppermost step of the display screen. Instead of this, a plurality of target images may be arranged and displayed in the element display regions AR[1, 4], AR[2, 4], AR[3, 4] and AR[4, 4] positioned in the lowermost step of the display screen. In either case, a plurality of target images are arranged and displayed in the horizontal direction of the display screen.

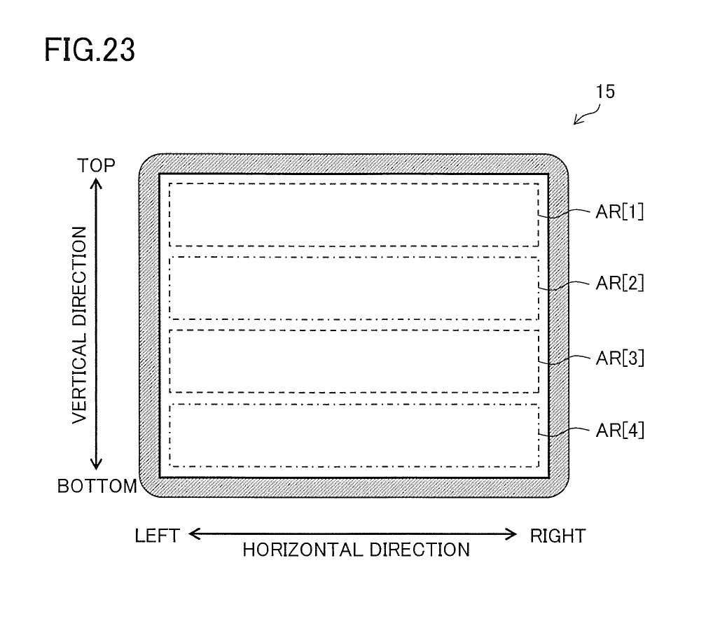

Although, in the example described above, the class display regions AR[1] to AR[4] are arranged in the horizontal direction on the display screen, as shown in FIG. 23, the display region of the display screen may be divided such that the class display regions AR[1] to AR[4] are arranged in the vertical direction on the display screen. In this case, the input images of the first to fourth classes are displayed in the class display regions AR[1] to AR[4], respectively. When, with the class display regions AR[1] to AR[4] arranged in the vertical direction, the rule α is applied, the target images are displayed in the element display regions arranged in the left ends of the class display regions AR[1] to AR[4] or the target images are displayed in the element display regions arranged in the right ends of the class display regions AR[1] to AR[4]. In other words, a plurality of target images are arranged and displayed in the vertical direction of the display screen. When, on the display screen, the regions AR[1] to AR[4] are arranged either in the horizontal direction or in the vertical direction, under the rule α, the target images are displayed in a predetermined specific display region on the display screen.

Although, in the example described above, the number of class display regions set on the display screen is 4, the number may be 2, 3 or 5 or more. Likewise, although, in the example described above, the number of element display regions provided in each of the class display regions is 4, the number may be 2, 3 or 5 or more.

### Second Embodiment

A second embodiment of the present invention will be described. The second embodiment is based on the first embodiment; unless a contradiction arises, the description of the first embodiment can be applied to that of the second embodiment. In the second embodiment, a display operation that is performed while the slide show is being reproduced will be described.

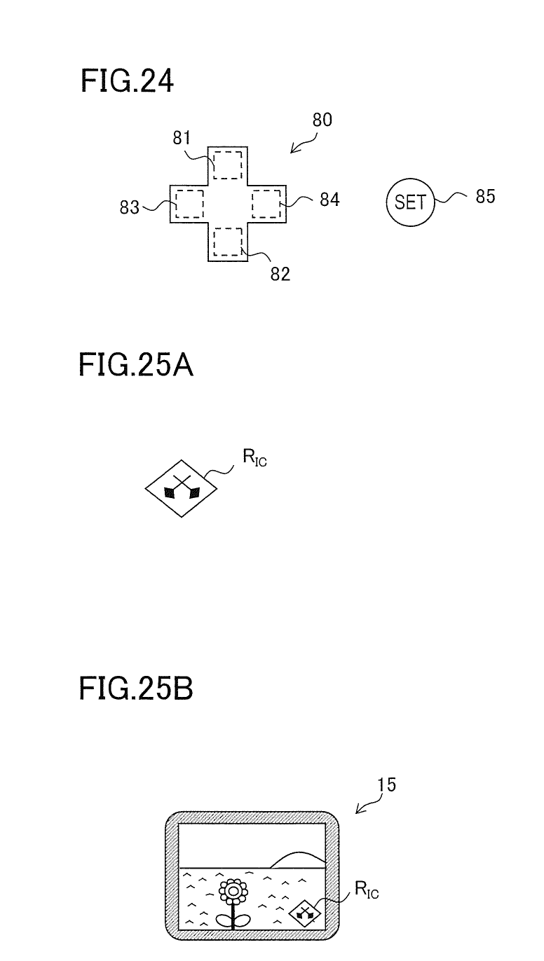

FIG. 24 shows a cross key 80 and a set key 85 that can be provided in the operation portion 17. The cross key 80 is a combination of an upward direction key 81, a downward direction key 82, a leftward direction key 83 and a rightward direction key 84. The user presses down the upward direction key 81, and can thereby provide an instruction allocated to the upward direction key 81 to the image sensing device 1 (the same is true of the keys 82 to 85).

All target images are individually reproduced once and thus one round of slide show reproduction is completed, and, after the completion of the one round of slide show reproduction, the image sensing device 1 can perform the slide show reproduction one more time either according to an instruction from the user or automatically. In the image sensing device 1, while the p-th round of slide show reproduction is being performed, target images for the (p+1)-th round of slide show reproduction can be set or target images for the rounds of slide show reproduction subsequent to the (p+1)-th round of slide show reproduction can be set. In the following description, it is assumed that, while the p-th round of slide show reproduction is being performed, target images for the (p+1)-th round of slide show reproduction and the rounds of slide show reproduction subsequent to the (p+1)-th round of slide show reproduction can be set. Here, p is a natural number. If the p-th round of slide show reproduction is regarded as the current round of slide show reproduction, the (p+1)-th round of slide show reproduction and the rounds of slide show reproduction subsequent to the (p+1)-th round of slide show reproduction can be respectively referred to as the next round of slide show reproduction and the rounds of slide show reproduction subsequent to the next round of slide show reproduction.

It is assumed that, as in the first embodiment, the initial classification shown in FIG. 11 is performed, and that a state where only the input images 301, 302, 304 and 308 among the input images 301 to 308 are set at target images (hereinafter referred to as an initial set state ST_{A}) is the starting point. Although, in the first embodiment, it has been described that, in the slide show reproduction, a non-target image may be reproduced only for the short time period tₛ, in the following description, unless particularly otherwise specified, the time period tₛ is assumed to be zero.

When, with the initial set state ST_{A} being maintained, a plurality of rounds of slide show reproduction are repeatedly performed, in the first round of slide show reproduction, only the input images 301, 302, 304 and 308 are sequentially displayed, and thereafter, in the second round of slide show reproduction, only the input images 301, 302, 304 and 308 are sequentially displayed again (the same is true of the following rounds of slide show reproduction). However, when, while a certain target image is being displayed, an image associated with the target image is present, the display control portion 53 displays, while the target image is being displayed, an association icon R_{IC} indicating that the image associated with the target image is present. The image associated with the certain target image indicates a non-target image that belongs to the same class as the target image. Hence, for example, in the initial set state ST_{A} (see FIG. 11), an image associated with the input image 302 that is a target image is the input image 303 that is a non-target image; images associated with the input image 304 that is a target image are the input images 305 to 307 that are non-target images.

An example of the association icon R_{IC} is shown in FIG. 25A. FIG. 25B shows a state where the association icon R_{IC} is displayed. In the example of FIG. 25B, the target image displayed on the display screen is the input image 302 (see FIG. 11). As shown in FIG. 25B, the association icon R_{IC} may be superimposed and displayed on the input image 302; in an example that differs from the example of FIG. 25B, the association icon R_{IC} and the input image 302 may be arranged side by side and displayed simultaneously.

The display modes of the slide show reproduction include a normal display mode in which only the target images are sequentially displayed at given time intervals and an association image display mode in which only the non-target images or the target images and the non-target images are sequentially displayed at given time intervals. First to sixth specific examples will be described below as specific examples of the slide show reproduction including an example of the operation of switching the display modes. Unless a contradiction arises, what is described in a certain specific example can be applied to another specific example.

### First Specific Example

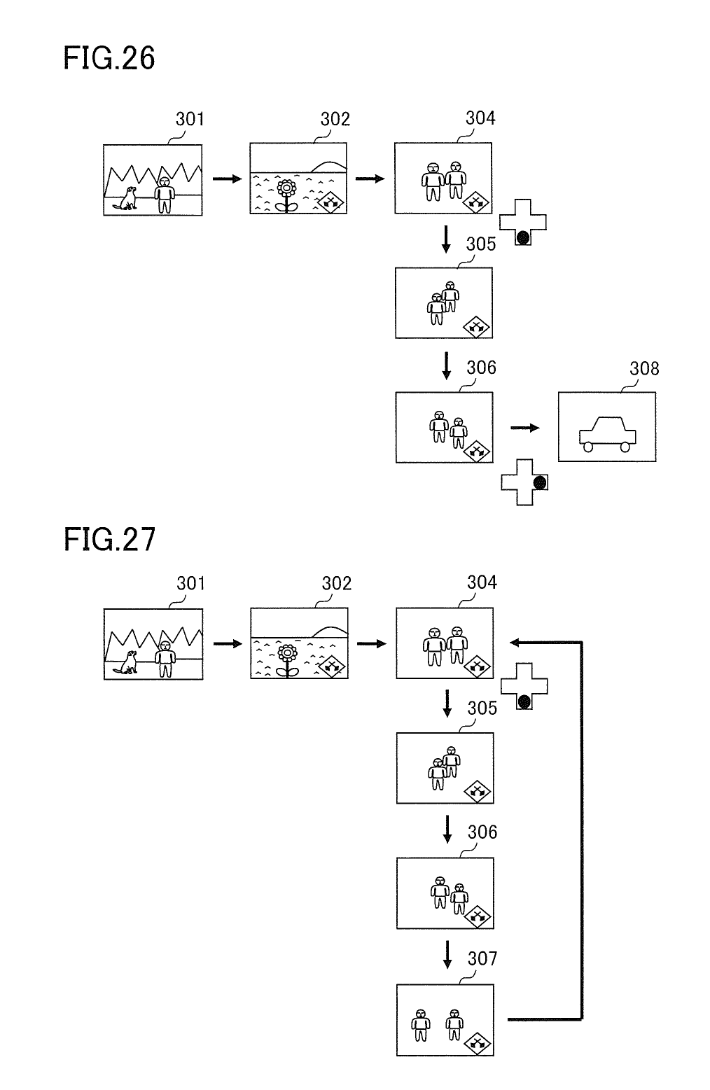

The first specific example will be described. FIG. 26 is a diagram showing how images displayed in the first specific example are changed. In the first specific example, it is assumed that the p-th round of slide show reproduction is started in the initial set state ST_{A}, that the downward direction key 82 is pressed down at a timing T_{A1} when the input image 304 is displayed as a target image in the p-th round of slide show reproduction and that the rightward direction key 84 is then pressed down at a timing T_{A2}.

When the p-th round of slide show reproduction is started in the initial set state ST_{A}, the display mode is set at the normal display mode, and the input images 301, 302 and 304 are sequentially displayed. When the downward direction key 82 is pressed down at the timing T_{A1} when the input image 304 is displayed, the display mode is changed from the normal display mode to the association image display mode, and, after the input image 304, the input images 305 and 306 that are images associated with the input image (target image) 304 are sequentially displayed. When the rightward direction key 84 is pressed down at the timing T_{A2} when the input image 306 is displayed, the display mode is returned from the association image display mode to the normal display mode, and the target image 308 of a class subsequent to the class to which the target image 304 belongs (that is, the target image of the fourth class) is displayed.

When the image associated with the target image is displayed in the association image display mode, the association icon R_{IC} may be displayed together with the associated image (the same is true of the other specific examples, which will be described later). The association icon R_{IC} that is displayed together with the target image and the association icon R_{IC} that is displayed together with the associated image which is a non-target image may differ in the design of the association icon R_{IC} from each other (the same is true of the other specific examples, which will be described later).

The input image 306 that is displayed last in the association image display mode is newly set at a target image (in other words, it is selected as a new target image). Accordingly, the input image 304 that has been the target image in the p-th round of slide show reproduction is changed to a non-target image. In other words, the pressing-down operation performed in the p-th round of slide show reproduction switches the target image belonging to the third class from the input image 304 to the input image 306. Hence, in the (p+1)-th round of slide show reproduction and the rounds of slide show reproduction subsequent to the (p+1)-th round of slide show reproduction, the input images 301, 302, 306 and 308 are sequentially displayed (the input image 304 is not displayed).

When the input image 306 is changed from the non-target image to the target image, the input image 304 may fail to be changed from the target image to the non-target image, and the input image 304 may be kept set at the target image.

### Second Specific Example

The second specific example will be described. FIG. 27 is a diagram showing how images displayed in the second specific example are changed. In the second specific example, it is assumed that the p-th round of slide show reproduction is started in the initial set state ST_{A}, and that the downward direction key 82 is pressed down at a timing T_{B1} when the input image 304 is displayed as a target image in the p-th round of slide show reproduction.

When the p-th round of slide show reproduction is started in the initial set state ST_{A}, the display mode is set at the normal display mode, and the input images 301, 302 and 304 are sequentially displayed. When the downward direction key 82 is pressed down at the timing T_{B1} when the input image 304 is displayed, the display mode is changed from the normal display mode to the association image display mode, and, after the input image 304, the input images 305, 306 and 307 that are images associated with the input image (target image) 304 are sequentially displayed. If, after the input image 307 is displayed for a predetermined time period, the user operation including the operation of pressing down the rightward direction key 84 is not performed, the input images 304, 305, 306 and 307 are again displayed sequentially and repeatedly, with the input image 304 being started in this display.

### Third Specific Example

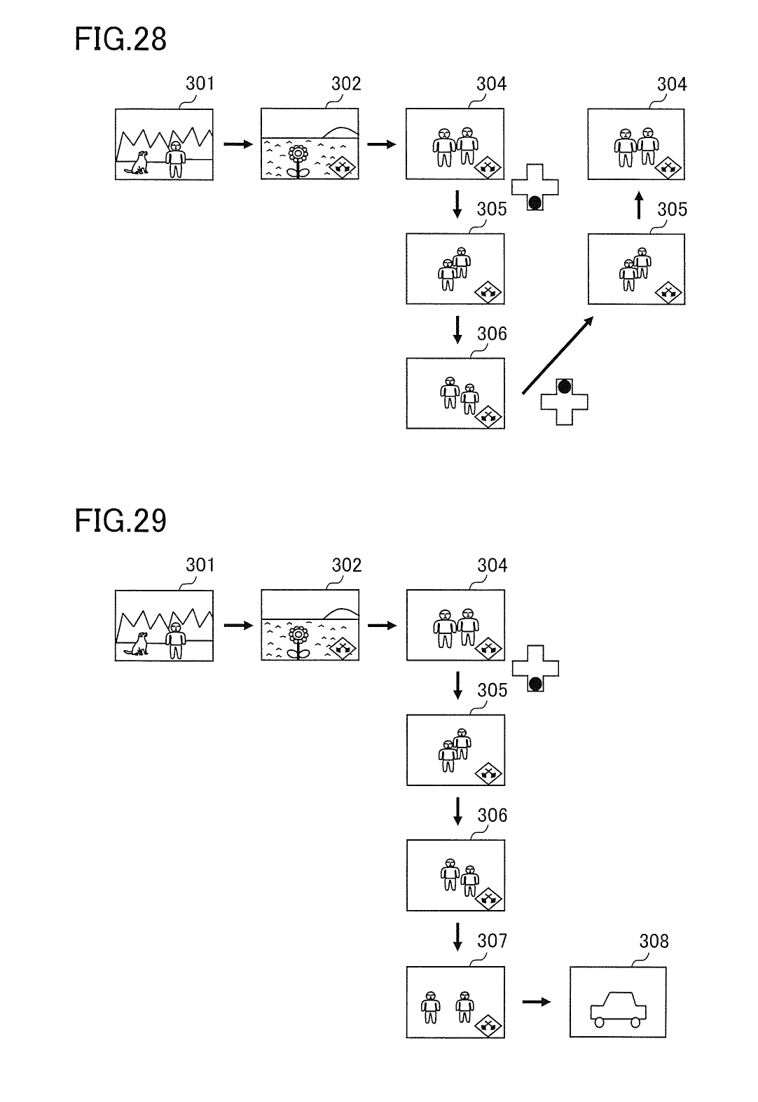

The third specific example will be described. FIG. 28 is a diagram showing how images displayed in the third specific example are changed. In the third specific example, it is assumed that the p-th round of slide show reproduction is started in the initial set state ST_{A}, that the downward direction key 82 is pressed down at a timing T_{C1} when the input image 304 is displayed as a target image in the p-th round of slide show reproduction and that the upward direction key 81 is then pressed down at a timing T_{C2} when the input image 306 is displayed as a non-target image.

When the p-th round of slide show reproduction is started in the initial set state ST_{A}, the display mode is set at the normal display mode, and the input images 301, 302 and 304 are sequentially displayed. When the downward direction key 82 is pressed down at the timing Tₒ when the input image 304 is displayed, the display mode is changed from the normal display mode to the association image display mode, and, after the input image 304, the input images 305 and 306 that are images associated with the input image (target image) 304 are sequentially displayed. When the upward direction key 81 is pressed down at the timing T_{C2} when the input image 306 is displayed, while the association image display mode is maintained, after the input image 306, the input images 305 and 304 are sequentially displayed in this order. Specifically, at the timing T_{C2}, the order of display of the input images belonging to the third class is reversed

If, after the timing T_{C2}, the downward direction key 82 is pressed down again when the input image 304 is displayed, after the input image 304, the input images 305 and 306 (and furthermore the input image 307) are sequentially displayed, although this is not shown in FIG. 28. If, after the timing T_{C2}, the rightward direction key 84 is pressed down when the input image 305 is displayed, the display mode is returned from the association image display mode to the normal display mode, and the target image 308 of a class subsequent to the class to which the target image 304 belongs (that is, the target image of the fourth class) is displayed; on the other hand, as in the first specific example, the input image 305 that is displayed last in the association image display mode is set at a target image in the (p+1)-th round of slide show reproduction and the rounds of slide show reproduction subsequent to the (p+1)-th round of slide show reproduction. Accordingly, the input image 304 that has been the target image in the p-th round of slide show reproduction may be changed to a non-target image or the input image 304 may be kept set at the target image.

### Fourth Specific Example

The fourth specific example will be described. FIG. 29 is a diagram showing how images displayed in the fourth specific example are changed. In the fourth specific example, it is assumed that the p-th round of slide show reproduction is started in the initial set state ST_{A}, and that the downward direction key 82 is pressed down at a timing T_{D1} when the input image 304 is displayed as a target image in the p-th round of slide show reproduction.

When the p-th round of slide show reproduction is started in the initial set state ST_{A}, the display mode is set at the normal display mode, and the input images 301, 302 and 304 are sequentially displayed. When the downward direction key 82 is pressed down at the timing T_{D1} when the input image 304 is displayed, the display mode is changed from the normal display mode to the association image display mode, and, after the input image 304, the input images 305, 306 and 307 that are images associated with the input image (target image) 304 are sequentially displayed. If, after the input image 307 is displayed for a predetermined time period, the user operation including the operation of pressing down the rightward direction key 84 is not performed, the display control portion 53 automatically returns the display mode from the association image display mode to the normal display mode (that is, returns the display mode to the normal display mode when, in the association image display mode, the display of the images associated with the input image 304 is all completed). Hence, after the input image 307, the target image 308 of a class subsequent to the class to which the target image 304 belongs (that is, the target image of the fourth class) is displayed.

The input image 307 that is displayed last in the association image display mode is set at a new target image (in other words, it is selected as a new target image). In other words, the input image 307 is set at a target image in the (p+1)-th round of slide show reproduction and the rounds of slide show reproduction subsequent to the (p+1)-th round of slide show reproduction. Accordingly, the input image 304 that has been the target image in the p-th round of slide show reproduction may be changed to a non-target image or the input image 304 may be kept set at the target image. If, while the input image 307 is being displayed, a predetermined operation (for example, the operation of pressing down the rightward direction key 84) is not be performed by the user, the input image 307 may be kept set at the non-target image.

### Fifth Specific Example

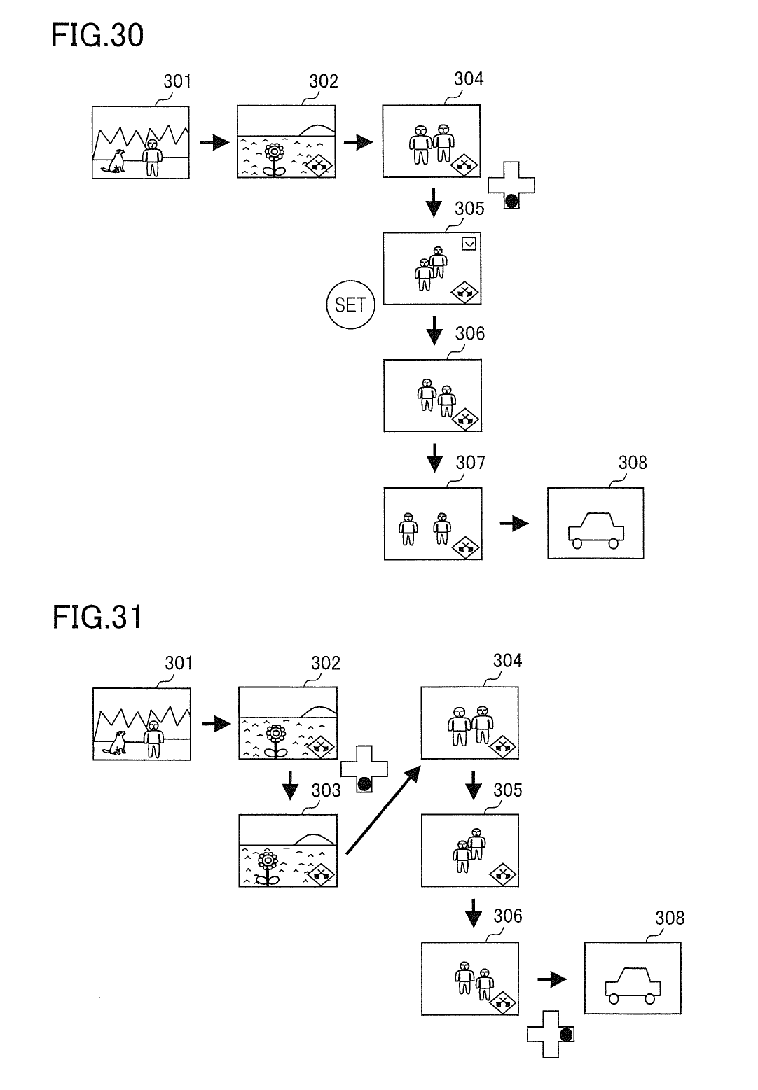

The fifth specific example will be described. FIG. 30 is a diagram showing how images displayed in the fifth specific example are changed. In the fifth specific example, it is assumed that the p-th round of slide show reproduction is started in the initial set state ST_{A}, that the downward direction key 82 is pressed down at a timing T_{E1} when the input image 304 is displayed as a target image in the p-th round of slide show reproduction and that the set key 85 is pressed down at the following timing T_{E2}.

When the p-th round of slide show reproduction is started in the initial set state ST_{A}, the display mode is set at the normal display mode, and the input images 301, 302 and 304 are sequentially displayed. When the downward direction key 82 is pressed down at the timing T_{E1} when the input image 304 is displayed, the display mode is changed from the normal display mode to the association image display mode, and, after the input image 304, the input images 305, 306 and 307 that are images associated with the input image (target image) 304 are sequentially displayed. If, after the input image 307 is displayed for a predetermined time period, the user operation including the operation of pressing down the rightward direction key 84 is not performed, the display control portion 53 automatically returns the display mode from the association image display mode to the normal display mode (that is, returns the display mode to the normal display mode when, in the association image display mode, the display of the images associated with the input image 304 is all completed). Hence, after the input image 307, the target image 308 of a class subsequent to the class to which the target image 304 belongs (that is, the target image of the fourth class) is displayed.

When the user presses down the set key 85 in the association image display mode, the associated image that is displayed at the time of the pressing down is set at a new target image (in other words, is selected as a new target image). In the fifth specific example, it is assumed that the set key 85 is pressed down at a timing T_{E2} when the input image 305 is displayed. When the set key 85 is pressed down at the timing T_{E2}, the display control portion 53 displays the check box CB of the second check state together with the input image 305 (see FIG. 16B), and explicitly shows that the input image 305 is set at a new target image. By pressing down the set key 85 again while the input image 305 is being displayed, the user can cancel the setting of the input image 305 at a new target image; when this cancellation is performed, the state of the check box CB displayed together with the input image 305 is changed from the second check state to the first check state (see FIG. 16B). The user can also perform, on the input images 306 and 307, the same operation as the operation performed on the input image 305.

The operation of pressing down the set key 85 at the timing T_{E2} causes the input image 305 to become the target image in the (p+1)-th round of slide show reproduction and the rounds of slide show reproduction subsequent to the (p+1)-th round of slide show reproduction. Accordingly, the input image 304 that has been the target image in the p-th round of slide show reproduction may be changed to a non-target image or the input image 304 may be kept set at the target image.

### Sixth Specific Example

The sixth specific example will be described. FIG. 31 is a diagram showing how images displayed in the sixth specific example are changed. In the sixth specific example, it is assumed that the p-th round of slide show reproduction is started in the initial set state ST_{A}, that the downward direction key 82 is pressed for a long time at a timing T_{F1} when the input image 302 is displayed as a target image in the p-th round of slide show reproduction and that the rightward direction key 84 is then pressed down at the following timing T_{F2}. The operation of pressing the downward direction key 82 for a long time and the operation of pressing down the downward direction key 82 differ from each other. The operation of pressing the downward direction key 82 for a long time refers to an operation of continuously pressing the downward direction key 82 for a predetermined time period or more; the operation of pressing down the downward direction key 82 refers to an operation of pressing the downward direction key 82 for a time period less than a predetermined time period.

As shown in FIG. 31, in the sixth specific example, once the display mode is changed from the normal mode to the association image display mode, the display in the association image display mode is continued over a plurality of classes until the user performs a predetermined operation.

Specifically, when the p-th round of slide show reproduction is started in the initial set state ST_{A}, the display mode is set at the normal display mode, and the input images 301 and 302 are sequentially displayed. When the downward direction key 82 is pressed for a long time at the timing T_{F1} when the input image 302 is displayed, the display mode is changed from the normal display mode to the association image display mode, and, after the input image 302, the input image 303 that is an image associated with the input image (target image) 302 is displayed. The image associated with the input image 302 is only the input image 303. Hence, if, after the input image 303 is displayed for a predetermined time period, the user operation including the operation of pressing down the rightward direction key 84 is not performed, the display control portion 53 displays the target image 304 of a class subsequent to the class to which the target image 302 belongs (that is, the target image of the third class), and furthermore, after the input image 304, the input images 305 and 306 associated with the input image 304 are sequentially displayed. In the sixth specific example, the rightward direction key 84 is pressed down at the timing T_{F2} when the input image 306 is displayed. Then, the display control portion 53 returns the display mode from the association image display mode to the normal display mode, and displays the target image 308 of a class subsequent to the class to which the target image 304 belongs (that is the target image of the fourth class).

In the association image display mode, the input images (that is, the input images 303 and 306) that are displayed last in each class are set at new target images (in other words, are selected as new target images). Specifically, the input images 303 and 306 are respectively set at target images in the (p+1)-th round of slide show reproduction and the rounds of slide show reproduction subsequent to the (p+1)-th round of slide show reproduction. Accordingly, the input images 302 and 304 that have been the target images in the p-th round of slide show reproduction may be changed to non-target images or the input images 302 and 304 may be kept set at the target images. If, while the input image 303 is being displayed, a predetermined operation is not be performed by the user, the input image 303 may be kept set at the non-target image (the same is true of the input image 306).

As described above, when the image sensing device 1 of the second embodiment receives a predetermined operation (for example, the operation of pressing down the downward direction key 82) from the user while the p-th round of slide show reproduction is being performed, the image sensing device 1 changes the display mode from the normal display mode to the association image display mode, and displays an input image (that is a non-target image in the p-th round of slide show reproduction) that has not been selected as a target image in the p-th round of slide show reproduction. Then, the image sensing device 1 receives the selection (in other words, the selection operation) of target images in the (p+1)-th round of slide show reproduction and the rounds of slide show reproduction subsequent to the (p+1)-th round of slide show reproduction. Specifically, for example, when the target image 304 is displayed while the p-th round of slide show reproduction is being performed, if the image sensing device 1 receives a predetermined operation (for example, the operation of pressing down the downward direction key 82), the image sensing device 1 displays the non-target images (305, 306 and 307) of a class to which the input image 304 belongs, and receives the reselection (the reselection operation) of target images while this display is being performed. In other words, the image sensing device 1 receives the selection (in other words, the selection operation) of the target images in the (p+1)-th round of slide show reproduction and the rounds of slide show reproduction subsequent to the (p+1)-th round of slide show reproduction.

As described above, in the second embodiment, while the slide show reproduction is being performed, the association image display mode for displaying images associated with the input image can be started up, and, during that time, target images can be reselected. Since, in the association image display mode, the current target image and the associated image that is the current non-target image are continuously displayed, the user can rapidly reselect, while recognizing the relationship (similarity) between those images, the desired image as the target image.

Although, in each of the specific examples described above, the display mode is switched by the cross key 80 between the normal display mode and the association image display mode, an operation member and an operation method for realizing such switching can be changed variously. Likewise, although the method of selecting the target image with the set key 85 has been described above, the selection method can be changed variously. For example, the switching of the display mode and the selection of the target image may be realized by the use of the touch panel 19, a trackball or the like (not shown).

As in the first embodiment, even in a mode other than the association image display mode, in the slide show reproduction, a non-target image may be reproduced only for the short time period tₛ (in other words, the time period tₛ may be greater than zero). In other words, in the slide show reproduction of the normal display mode, it is alternatively possible not only to sequentially reproduce the target images but also to reproduce the non-target image only for a reproduction time period shorter than the reproduction time period of each target image. In this case, the operation of selecting or setting the target images can be said to be an operation of setting the reproduction time period of each input image. When the time period tₛ>0, the following operation can be performed.

In the slide show reproduction of the normal display mode, the input images 301 to 308 are sequentially displayed such that each target image is displayed for the reproduction time period t_{L} (for example, 3 seconds) and each non-target image is displayed for the reproduction time period tₛ (for example, 0.5 second). On the other hand, in the slide show reproduction of the association image display mode, the reproduction time period of the non-target image is increased such that the reproduction time period of each target image is equal to that of each non-target image. As described above, t_{L}>t_{S}.

For example, when the p-th round of slide show reproduction is started in the initial set state ST_{A}, the display mode is set at the normal display mode, the input images 301 and 302 that are target images are sequentially displayed, each for the time period t_{L}, then the input image 303 that is a non-target image is displayed only for the time period t_{S} and thereafter the input image 304 that is a target image is displayed only for the time period t_{L}. When the downward direction key 82 is pressed down while the input image 304 is being displayed, the display mode is changed from the normal display mode to the association image display mode, and the input images 305, 306 and 307 that are non-target images are displayed, each for the time period t_{L}. Then, if the rightward direction key 84 is pressed down at a timing when the input image 306 is displayed, the input image 306 is set at a target image in the (p+1)-th round of slide show reproduction and the rounds of slide show reproduction subsequent to the (p+1)-th round of slide show reproduction.

After this setting, when the (p+1)-th round of slide show reproduction or the round of slide show reproduction subsequent to the (p+1)-th round of slide show reproduction is started, in the normal display mode, the input images 301 and 302 that are target images are sequentially displayed, each for the time period t_{L}, then the input image 303 that is a non-target image is displayed only for the time period t_{S}, thereafter the input image 306 that is a target image is displayed only for the time period t_{L} and thereafter the input images 304, 305 and 307 that are non-target images are sequentially displayed, each for the time period t_{S}. If the input image 304 is kept set at the target image, the reproduction time period of the input image 304 is t_{L}.

### Third Embodiment

A third embodiment of the present invention will be described. Unless a contradiction arises, the description of the first and second embodiments can be applied to that of the third embodiment and a fourth embodiment to be described later. The overall configuration of the image sensing device 1 according to the third embodiment is the same as in the first embodiment or the second embodiment.

The image sensing device 1 has an image edition function of processing an input image and a slide show function of sequentially reproducing a plurality of input images on the display portion 15. As described above, the input image is an arbitrary still image or moving image.

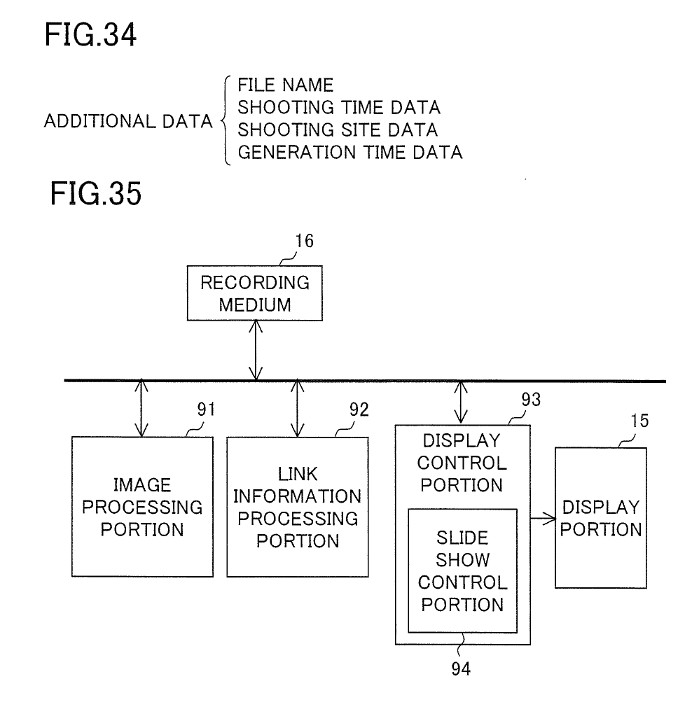

As shown in FIG. 34, in addition to the file name, the shooting time data and the shooting site data (see FIG. 4), generation time data that indicates the generation time of an input image corresponding to the image file and like can be included in the additional data to a certain image file.

When an input image is a moving image, for example, the shooting time of the input image is assumed to be, for example, the shooting start time of the moving image as the input image. When a certain input image is an image itself that is obtained by being shot with the image sensing device 1 (that is, when the certain input image is not an image that is obtained by being subjected to process edition processing, which will be described later), the shooting time of the input image agrees with the generation time. When an input image stored in an image file is an image that is obtained by being subjected to the process edition processing, which will be described later, since the generation time of the input image is a time when the process edition processing is performed, the shooting time of the input image differs from the generation time. Only any one of the shooting time data and the generation time data may be included in the additional data.

FIG. 35 shows a block diagram of a portion that is particularly involved in the realization of the image edition function and the slide show function. An image processing portion 91, a link information processing portion 92 and a display control portion 93 can be provided in, for example, the main control portion 13 of FIG. 1. A slide show control portion 94 is provided in the display control portion 93.

The image processing portion 91 can freely process, according to an edition instruction from the user, an arbitrary input image recorded in the recording medium 16. An arbitrary instruction from the user including the edition instruction can be realized by performing an operation on the touch panel 19 or the operation portion 17. Processing for processing the input image according to the edition instruction is referred to as the process edition processing. Arbitrary processing for changing image data on the input image according to the edition instruction corresponds to the process edition processing on the input image. For example, processing for changing the brightness, the chroma or the hue of all or part of the input image, processing for enlarging or reducing the image size of the input image, processing for cutting part of the input image (that is, trimming of the input image) and processing for superimposing an arbitrary index (such as a character or an icon) on the input image correspond to the process edition processing on the input image.

The link information processing portion 92 generates link information as necessary, and records the link information in the recording medium 16. The significance of the link information and the method of utilizing the link information will be described later.

The display control portion 93 performs control for displaying, on the display screen of the display portion 15, an arbitrary input image read from the recording medium 16 or an image based on an input image. The slide show control portion 94 performs processing for sequentially reproducing a plurality of input images using the display portion 15. To sequentially reproduce a plurality of input images at given intervals is referred to as the slide show reproduction. The reproduction of the input image means the display of the input image on the display screen.

In the following description, when it is necessary to distinguish between an input image that has not been subjected to the process edition processing and an input image that is obtained by being subjected to the process edition processing, the former input image is particularly referred to as an original image, and the latter input image is particularly referred to as a processed image. A still image or moving image that is obtained by being shot with the image sensing device 1 is first recorded in the recording medium 16 without being subjected to the process edition processing. The still image or moving image that is recorded at this point is the original image. Thereafter, when the process edition processing is performed on the original image, the original image that has been subjected to the process edition processing (that is, an image that is obtained by performing the process edition processing on the original image) is the processed image.

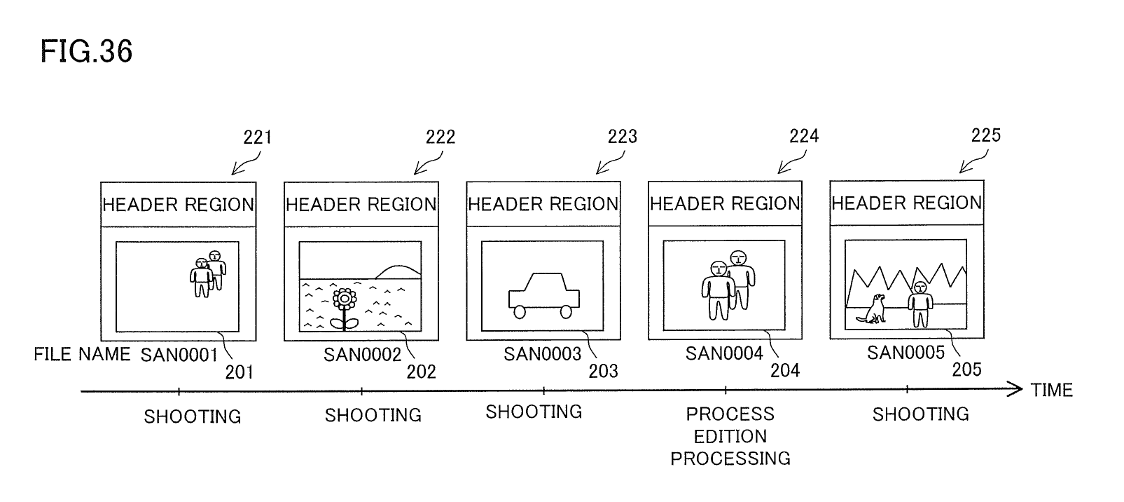

It is now assumed that five input images 201 to 205 shown in FIG. 36 are recorded in the recording medium 16. FIG. 36 shows five image files that store image data on the input images 201 to 205. The image data on the input images 201 to 205 is stored in the image files 221 to 225, respectively.

At least one or more of the input images 201 to 205 may be a moving image. If the input image 201 is a moving image, the reproduction of the input image 201 while the slide show reproduction is being performed is the reproduction of a typical frame (for example, the first frame) of the moving image as the input image 201 or the reproduction of part or all of the moving image as the input image 201. Here, all the input images 201 to 205 are assumed to be still images. It is also assumed that the input images 201, 202, 203 and 205 are original images and that the input image 204 is a processed image.

It is assumed that the input image 201 is first shot, that the input image 202 is then shot and that the input image 203 is thereafter shot. It is assumed that, after the input image 203 is shot, the process edition processing is performed to process the input image 201, and that the input image 204 is generated by performing the process edition processing on the input image 201. For example, an image that is obtained by cutting part of the input image 201 is assumed to be the input image 204. After the generation of the input image 204, the input image 205 is assumed to be shot. Hence, among the shooting times of the input images 201, 202, 203 and 205, the shooting time of the input image 201 is the earliest, and the shooting time of the input image 205 is the latest. Since the input image 204 is an image based on the input image 201, the shooting time of the input image 204 can be assumed to be the same as that of the input image 201; thus, it is possible to make shooting time data within the header region of an image file 224 agree with shooting time data within the header region of an image file 221. On the other hand, among the generation times of the input images 201 to 205, input images whose generation times are the first, the second, the third and the fourth earliest are the input images 201, 202, 203 and 204, respectively, and an input image whose generation time is the latest is the input image 205. It is also possible to make the shooting site data on a processed image agree with the shooting site data on an original image on which the processed image is based. Thus, it is possible to make the shooting site data within the header region of the image file 224 agree with the shooting site data within the header region of the image file 221.

Sequence numbers can be included in the file names. These sequence numbers are referred to as file numbers. Here, it is assumed that the file numbers “1”, “2”, “3”, “4”, “5”, . . . are given to input images in order from the input image whose generation time is the earliest to the input image whose generation time is the latest. Hence, the file numbers “1”, “2”, “3”, “4” and “5” are allocated to the file names of the image files 221, 222, 223, 224 and 225. In the example of FIG. 36, each file name is configured by placing “00” to the front of each file number and further placing “SAN” to the front of “00”.

The user uses the operation portion 17 or the touch panel 19, and thereby can provide an instruction to perform the slide show reproduction in which the input images 201 to 205 are included in the reproduction target. When this instruction is provided, the slide show control portion 94 can perform basic slide show reproduction α₁ that is one type of slide show reproduction.

In the basic slide show reproduction α₁, the input images 201 to 205 are simply arranged in order of file number, and they are sequentially reproduced one by one. Specifically, the input images 201 to 205 are sequentially reproduced one by one such that an input image to which a smaller file number is given is reproduced earlier. In other words, reproduction places of the first, the second, the third, the fourth, the fifth, . . . are given to input images in ascending order of file number. The input images are sequentially reproduced in ascending order of reproduction place (the same is true of improved slide show reproduction β₁ and the like, which will be described later). It is assumed that the i-th reproduction place is less than the (i+1)-th reproduction place.

Alternatively, in the basic slide show reproduction α₁, the input images 201 to 205 are simply arranged in order of generation time, and they are sequentially reproduced one by one. Specifically, the input images 201 to 205 are sequentially reproduced one by one such that an input image corresponding to an earlier generation time is reproduced earlier. In other words, the reproduction places of the first, the second, the third, the fourth, the fifth, . . . are given to input images in order from the input image corresponding to the earliest generation time to the input image corresponding to the latest generation time.

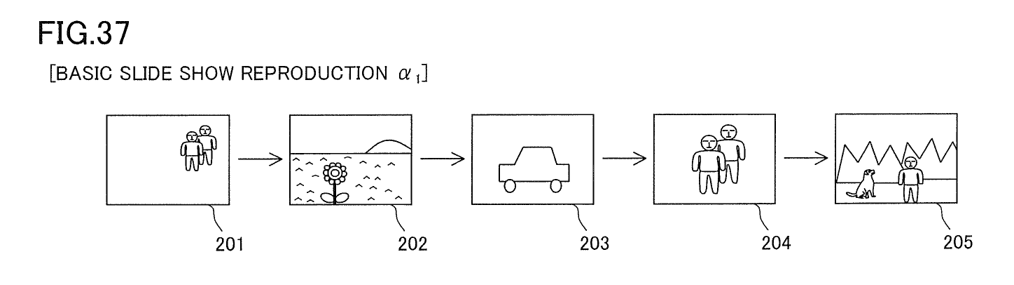

In all cases, in the basic slide show reproduction α₁, the reproduction order of the input images 201 to 205 are determined based on only the file numbers of the input images 201 to 205 or only the generation times of the input images 201 to 205; consequently, as shown in FIG. 37, the input images 201, 202, 203, 204 and 205 are sequentially reproduced in this order one by one. A reproduction order that the slide show control portion 94 determines in the basic slide show reproduction α₁ is particularly referred to as a basic reproduction order.

There are several points in the basic slide show reproduction α₁ that need to be improved. The slide show control portion 94 can perform the improved slide show reproduction β₁ that has benefits as compared with the basic slide show reproduction α₁. The improved slide show reproduction β₁ is also one type of slide show reproduction. In the following description of the third embodiment, unless particularly otherwise specified, the improved slide show reproduction β₁ is assumed to be performed as the slide show reproduction.

In order to realize the improved slide show reproduction β₁, the link information need to be generated and recorded by the link information processing portion 92 of FIG. 35. The link information indicates a correspondence relationship between a plurality of input images; the link information can also be said to indicate a correspondence relationship between a plurality of image files. As the method of generating and recording the link information, any one of link methods A₁ to A₃ can be employed.

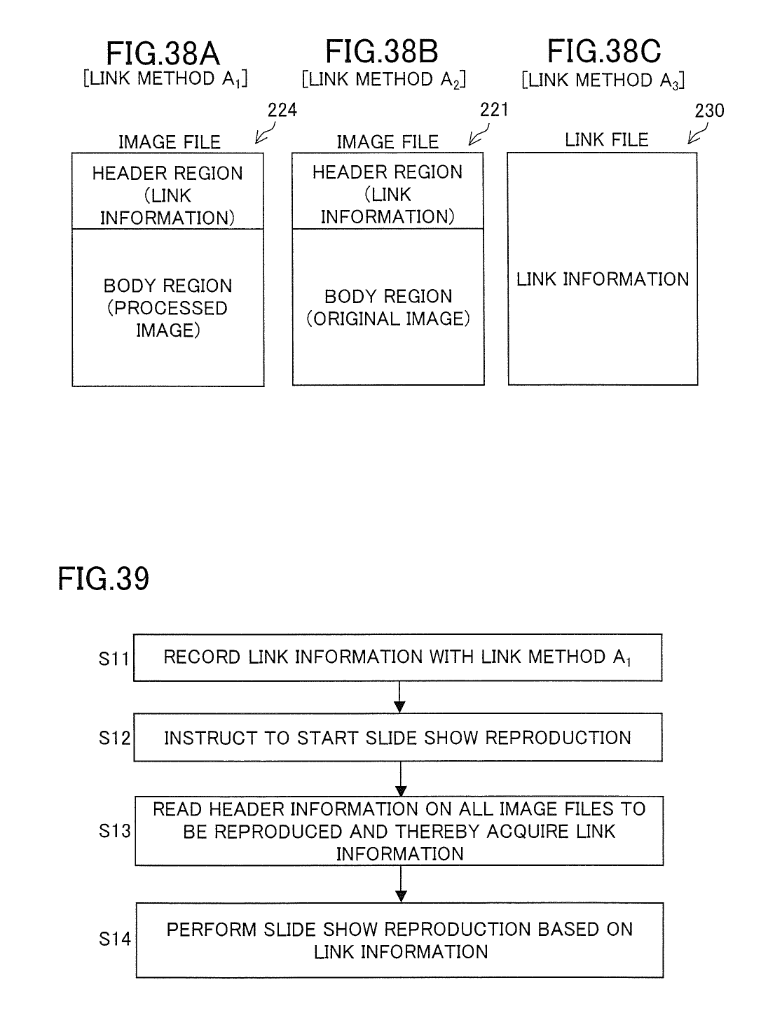

In the link method A₁, as shown in FIG. 38A, the link information is stored in the header region of the image file 224 that is the image file of a processed image, and is recorded in the recording medium 16. The link information stored in the header region of the image file 224 includes, for example, the file name of the image file 221.

In the link method A₂, as shown in FIG. 38B, the link information is stored in the header region of the image file 221 that is the image file of an original image, and is recorded in the recording medium 16. The link information stored in the header region of the image file 221 includes, for example, the file name of the image file 224.

In the link method A₃, as shown in FIG. 38C, a link file 230 that differs from the image files 221 to 225 is produced by the link information processing portion 92, and the link information is stored in the link file 230. The link file 230 including the link information is recorded in the recording medium 16.

Even when any one of the link methods A₁ to A₃ is employed, the link information indicates that the input image 204 is a processed image based on the input image 201 and that the input image 201 is an original image on which the processed image 204 is based.

As the specific procedure of performing the improved slide show reproduction β₁, specific procedures B₁ to B₃ will be described below. Even in any one of the specific procedures B₁ to B₃, if the link information is not recorded in the recording medium 16, the same reproduction as the basic slide show reproduction α₁ is performed.

[Specific Procedure B₁]

The specific procedure B₁ of the improved slide show reproduction β₁ will be described. In the specific procedure B₁, the link method A₁ corresponding to FIG. 38A is assumed to be employed. FIG. 39 is an operational flowchart of the image sensing device 1 in the specific procedure B₁.

First, in step S11, in the link method A₁, the link information is recorded in the header region corresponding to a processed image. Then, when, in step S12, an instruction to start the slide show reproduction is provided by the user, in step S13, the slide show control portion 94 reads, from the recording medium 16, header information on all image files to be reproduced, and thereby acquires the link information. The header information refers to data or information that is stored in the header region. Here, the link information is acquired from the header region of the image file 224. When the link information is acquired, in step S14, the slide show control portion 94 performs slide show reproduction (that is, the improved slide show reproduction β₁) based on the link information.

If, for example, power to the image sensing device 1 is interrupted while recording processing is being performed on a certain image file, the image file may be destroyed and thus it may be impossible to restore it. When the link method A₁ is utilized, since recording processing is not performed on the image file of an original image at the time of recording of the link information, the image file of the original image is prevented from being lost (or the loss of the image file is reduced).

In the slide show reproduction in step S14, any one of the following reproduction methods C₁ to C₄ can be employed.

Reproduction Method C₁

The reproduction method C₁ will be described. In the reproduction method C₁, the slide show control portion 94 identifies, based on the link information, which input image is an original image on which a processed image is based, omits the identified original image from the reproduction target and then performs the slide show reproduction. Hence, the input image 201 is omitted from the reproduction target and is not reproduced, and the input images 202 to 205 are sequentially reproduced as the reproduction target.

The slide show control portion 94 can set the reproduction order of the input images 202 to 205 with reference to the basic reproduction order described above.

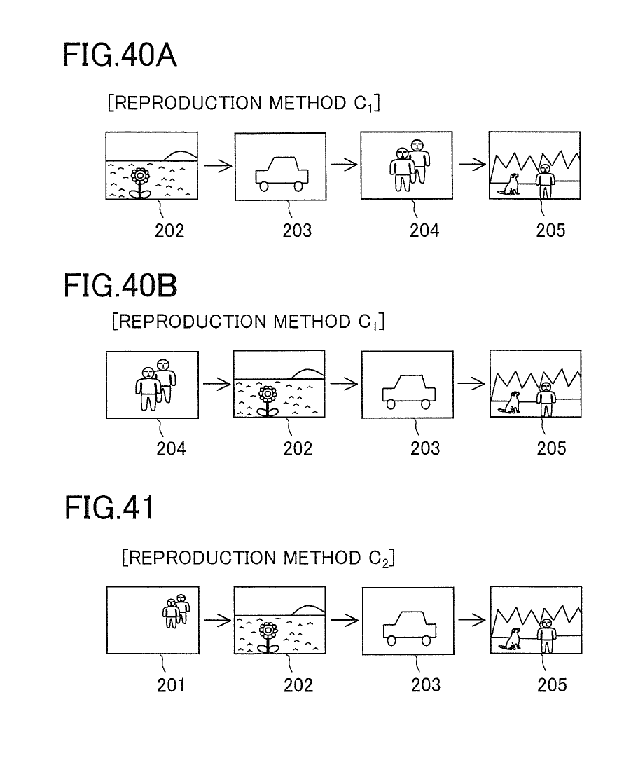

For example, based on the file numbers or the generation times of the input images 202 to 205, the reproduction order of the input images 202 to 205 can be determined. In this case, as shown in FIG. 40A, the first, second, third and fourth reproduction places are given to the input images 202, 203, 204 and 205, respectively. As described above, the input images are sequentially reproduced in ascending order of reproduction place.

For the input images 202, 203 and 205, the reproduction places are set based on the file numbers or the generation times whereas the reproduction place that should have been given to the original image 201 in the basic slide show reproduction α₁ may be given to the processed image 204. In this case, as shown in FIG. 40B, the first, second, third and fourth reproduction places are given to the input images 204, 202, 203 and 205, respectively.

Reproduction Method C₂

The reproduction method C₂ will be described. In the reproduction method C₂, the slide show control portion 94 identifies, based on the link information, which input image is a processed image, omits the processed image from the reproduction target and then performs the slide show reproduction. Hence, the input image 204 is omitted from the reproduction target and is not reproduced, and the input images 201 to 203 and 205 are sequentially reproduced as the reproduction target.

When the reproduction method C₂ is employed, the slide show control portion 94 can set the reproduction order of the input images 201 to 203 and 205 in the same method as in the basic slide show reproduction α₁. Consequently, in this case, as shown in FIG. 41A, the first, second, third and fourth reproduction places are given to the input images 201, 202, 203 and 205, respectively.

Since, in the basic slide show reproduction α₁, the original image 201 and the processed image 204 that is expected to be similar to the original image 201 are separately reproduced, the details of the reproduction can be redundant. Since, in the reproduction method C₁ or C₂, the reproduction of any one of the original image 201 and the processed image 204 is omitted, such redundancy is expected to be improved. Although, in the example of FIG. 41, the number of processed images whose reproduction is omitted is one, if a plurality of processed images are present, the reproduction of a plurality of processed images can be omitted.

Reproduction Method C₃

The reproduction method C₃ will be described. In the reproduction method C₃, the slide show control portion 94 identifies, based on the link information, which input image is a processed image and what input image is an original image on which the processed image is based and simultaneously reproduces the original image and the processed image identified.

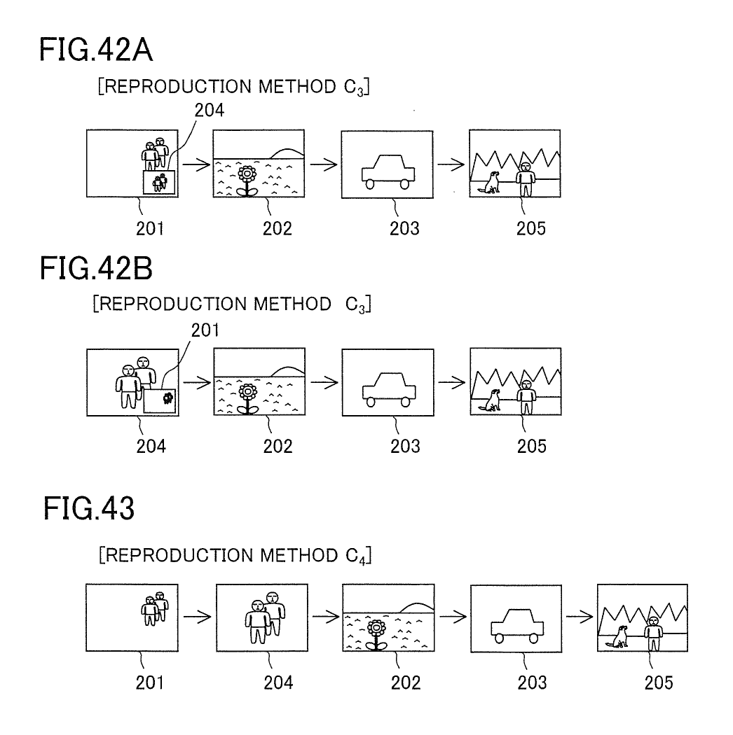

Specifically, for example, as shown in FIG. 42A, the processed image 204 is superimposed on the original image 201, and the original image 201 on which the processed image 204 is superimposed is displayed on the display screen. Here, it is possible to set, while equating the original image 201 on which the processed image 204 is superimposed and the simple original image 201, the reproduction order of the input images 201 to 203 and 205 in the same method as in the basic slide show reproduction α₁. In this case, the first, second, third and fourth reproduction places are given to the original image 201 on which the processed image 204 is superimposed and the input images 202, 203 and 205, respectively.

Alternatively, for example, as shown in FIG. 42B, the original image 201 is superimposed on the processed image 204, and the processed image 204 on which the original image 201 is superimposed is displayed on the display screen. Here, the reproduction place that should have been given to the original image 201 in the basic slide show reproduction α₁ may be given to the processed image 204 on which the original image 201 is superimposed. The reproduction places are given to the other input images in the same method as in the basic slide show reproduction α₁. Consequently, for example, the first, second, third and fourth reproduction places are given to the processed image 204 on which the original image 201 is superimposed and the input images 202, 203 and 205, respectively. By equating the processed image 204 on which the original image 201 is superimposed and the simple processed image 204, the first, second, third and fourth reproduction places may be given to the input image 202, the input image 203, the processed image 204 on which the original image 201 is superimposed and the input image 205, respectively. The method of simultaneously reproducing the original image and the processed image is not limited to the method described above; for example, the original image and the processed image may be arranged side by side on the display screen and simultaneously displayed.

Since, in the basic slide show reproduction α₁, the original image 201 and the processed image 204 that is expected to be similar to the original image 201 are separately reproduced, the details of the reproduction can be redundant. Since, in the reproduction method C₃, the original image 201 and the processed image 204 are simultaneously reproduced, such redundancy is expected to be improved.

Reproduction Method C₄

The reproduction method C₄ will be described. In the reproduction method C₄, the slide show control portion 94 identifies, based on the link information, which input image is a processed image and what input image is an original image on which the processed image is based and determines the reproduction order of a plurality of input images (in other words, changes the basic reproduction order described above) such that the original image and the processed image identified are reproduced continuously in time.

Specifically, the reproduction place given to the processed image 204 is changed from the reproduction place in the basic reproduction order such that the original image 201 and the processed image 204 are continuously reproduced. The reproduction places are given to the other input images (201 to 203 and 205) in the same method as in the basic slide show reproduction α₁. Consequently, as shown in FIG. 43, the first, second, third, fourth and fifth reproduction places are given to the input images 201, 204, 202, 203 and 205, respectively.

The slide show reproduction usually proceeds chronologically; a viewer of the slide show reproduction predicts or expects that the reproduction proceeds chronologically. The reproduction proceeds chronologically, and thus the reproduction images as a whole produce image effects similar to those of a story. If, as in the basic slide show reproduction α₁ (FIG. 37), the processed image 204 based on the original image 201 that is shot before the input images 202 and 203 is reproduced after the input images 202 and 203, such a story nature is removed. The reproduction method C₄ facilitates the maintenance of the story nature.

[Specific Procedure B₂]

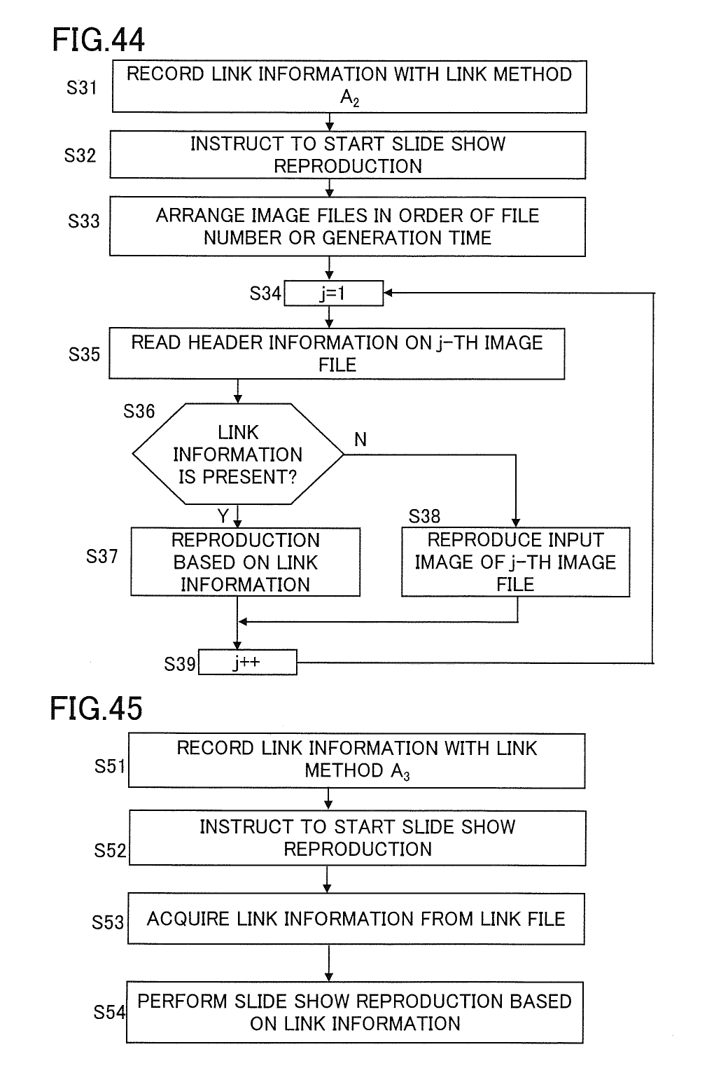

The specific procedure B₂ of the improved slide show reproduction β₁ will be described. In the specific procedure B₂, the link method A₂ corresponding to FIG. 38B is assumed to be employed. FIG. 44 is an operational flowchart of the image sensing device 1 in the specific procedure B₂.

First, in step S31, in the link method A₂, the link information is recorded in the header region corresponding to an original image. Then, when, in step S32, an instruction to start the slide show reproduction is provided by the user, in step S33, the slide show control portion 94 arranges all the image files to be reproduced in order of file number or generation time. Consequently, the image files 221 to 225 are set at the first to fifth image files, respectively. Then, in step S34, 1 is substituted into a variable j, and, in step S35 subsequent to step S34, the slide show control portion 94 reads header information on the j-th image file. Thereafter, in step S36, whether or not the read header information includes the link information is checked. If the read header information includes the link information, in step S37, the slide show control portion 94 performs the reproduction of the input image based on the link information whereas, if the read header information does not include the link information, in step S38, the slide show control portion 94 reproduces the input image of the j-th image file. After the reproduction in step S37 or S38, in step S39, 1 is added to the variable j, and then the process returns to step S35. Each type of processing in step S35 and the following steps is repeatedly performed until no image file of the reproduction target is present.

Any one of the reproduction methods C₁ to C₄ described above can be applied to the reproduction processing in step S37. In other words, the reproduction processing in step S37 can be performed such that the same reproduction result as in the slide show reproduction performed with the reproduction method C₁, C₂, C₃ or C₄ described above is obtained.

When the link method A₂ is employed, since the link information is present in the header region of the input image 201, the reproduction processing in step S37 is performed when j=1.

Hence, for example, based on the link information acquired when j=1, the original image 201 may be omitted from the reproduction target, and thereafter, as shown in FIG. 40A, the input images 202, 203, 204 and 205 may be sequentially reproduced in this order or as shown in FIG. 40B, the input images 204, 202, 203 and 205 may be sequentially reproduced in this order.

Alternatively, for example, based on the link information acquired when j=1, the processed image 204 may be omitted from the reproduction target, and thereafter, as shown in FIG. 41, the input images 201, 202, 203 and 205 may be sequentially reproduced in this order.

Alternatively, for example, based on the link information acquired when j=1, the original image 201 on which the processed image 204 is superimposed or the processed image 204 on which the original image 201 is superimposed may be generated, and thereafter, as shown in FIG. 42A, the original image 201 on which the processed image 204 is superimposed and the input images 202, 203 and 205 may be sequentially reproduced in this order or as shown in FIG. 42B, the processed image 204 on which the original image 201 is superimposed and the input images 202, 203 and 205 may be sequentially reproduced in this order.

Alternatively, for example, by giving the first and second reproduction places to the input images 201 and 204, respectively, based on the link information acquired when j=1, as shown in FIG. 43, the input images 201 and 204 may be continuously reproduced (thereafter, the input images 202, 203 and 205 are sequentially reproduced).

In the operation shown in FIG. 39, it is necessary to read all the header information on the image file to be reproduced before the slide show reproduction is actually started. By contrast, in the operation shown in FIG. 44, it is not necessary to do so. In other words, since the reproduction can be actually started without all the header information on the image file to be reproduced being read, it is possible to reduce a time lag between the provision of an instruction to start the slide show reproduction from the user and the start of the actual slide show reproduction.

Even when the link method A₂ corresponding to FIG. 38B is employed, as in the operation shown in FIG. 39, after the instruction to start the slide show reproduction (in other words, after step S32 of FIG. 44), the processing in steps S13 and S14 of FIG. 39 may be performed.

[Specific Procedure B₃]

The specific procedure B₃ of the improved slide show reproduction β₁ will be described. In the specific procedure B₃, the link method A₃ corresponding to FIG. 38C is assumed to be employed. FIG. 45 is an operational flowchart of the image sensing device 1 in the specific procedure B₃.

First, in step S51, in the link method A₃, the link information is stored in the link file 230 and is recorded in the recording medium 16. Then, when, in step S52, an instruction to start the slide show reproduction is provided by the user, in step S53, the slide show control portion 94 reads the link file 230 from the recording medium 16, and thereby acquires the link information. Thereafter, in step S54, the slide show control portion 94 performs the slide show reproduction (that is, the improved slide show reproduction β₁) based on the link information. The slide show reproduction in step S54 is the same as in step S14 of FIG. 39. Thus, it is possible to perform the slide show reproduction in step S54 by utilizing any one of the reproduction methods C₁ to C₄ described above.

It can also be considered that a list obtained by listing pieces of header information which are sequentially read by repeating step S35 of FIG. 44 is stored in the link file 230. Hence, after steps 51 and S52 of FIG. 45, not the processing in step S53 and S54 but the same processing as in steps S33 to S39 of FIG. 44 may be performed.

When the link method A₃ is utilized, since recording processing is not performed on the image files of the original image and the processed image at the time of recording of the link information, the image files of the original image and the processed image are prevented from being lost (or the loss of the image files is reduced).

[Application B₄]

An application B₄ of the improved slide show reproduction β₁ will be described. The user uses the touch panel 19 or the operation portion 17, and thereby can provide an instruction to perform various file operations to the image sensing device 1. The file operations include, for example, processing for changing the file name of a certain image file and processing for removing a certain image file from the recording medium 16.

Although the link information indicates a correspondence relationship between a plurality of input images, a problem may occur if, after the production of the link information, the file name of an image file related to the link information is changed or an image file related to the link information is removed.

For example, in a case where the link method A₂ of FIG. 38B is employed, when, as shown in FIG. 36, the image files 221 to 223 storing the input images 201 to 203 are recorded, and then the process edition processing on the input image 201 is performed to generate the input image 204 and the image file 224, the file name “SAN0004” of the image file 224 is written as the link information in the header region of the image file 221. Thereafter, if the image file 224 is removed by the file operation, and a new file name “SAN0004” is given to an image file storing an input image other than the input image 204, the input image that is not associated with the input image 201 at all is treated as the processed image of the input image 201, and the slide show reproduction is performed. This problem needs to be avoided.

Hence, in the application B₄, a method of strengthening the reliability of the correspondence relationship indicated by the link information is proposed. The method of strengthening the reliability can be applied to any one of the specific procedures B₁ to B₃. As will be described below, whether or not the link information is valid or invalid is determined, and thus it is possible to strengthen the reliability.

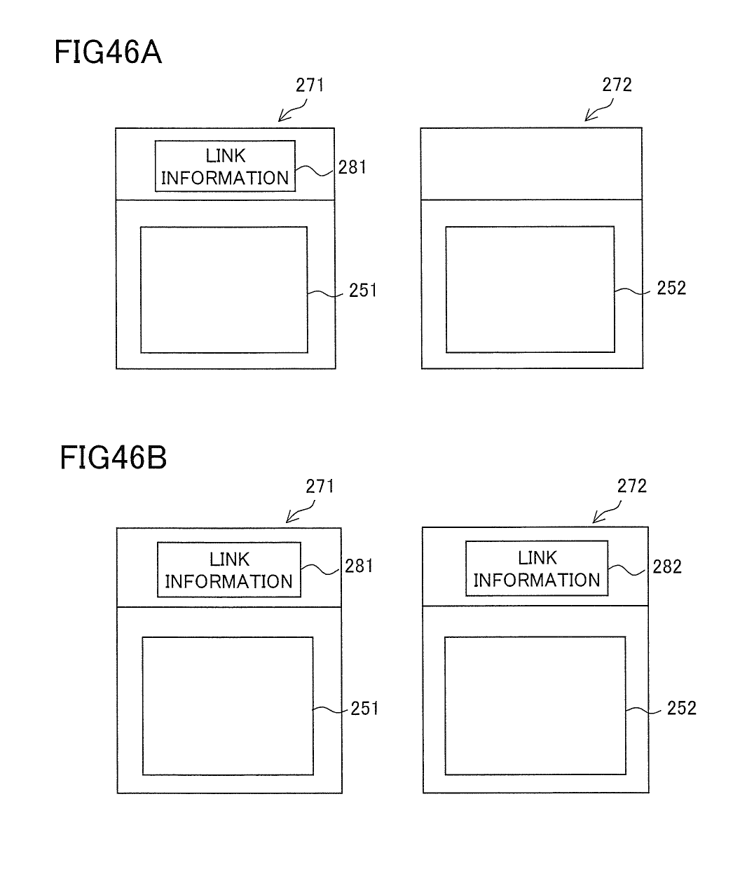

It is now assumed that, as shown in FIG. 46A, input images 251 and 252 are stored in image files 271 and 272, respectively, and that link information 281 indicates that the input image 252 is a processed image based on the original image 251; the method of strengthening the reliability will be described. The link information 281 is, for example, the file name of the image file 272 stored in the header region of the image file 271.

If the input image 252 is the processed image based on the original image 251, pieces of shooting time data on those images should agree with each other. Hence, a condition (hereinafter referred to as a first condition) under which the pieces of shooting time data on the image files 271 and 272 agree with each other may be set, and, if the first condition is satisfied, the link information 281 may be determined to be valid whereas, if the first condition is not satisfied, the link information 281 may be determined to be invalid.

If the input image 252 is the processed image based on the original image 251, pieces of shooting site data on those images should agree with each other. Hence, a condition (hereinafter referred to as a second condition) under which the pieces of shooting site data on the image files 271 and 272 agree with each other may be set, and, if the second condition is satisfied, the link information 281 may be determined to be valid whereas, if the second condition is not satisfied, the link information 281 may be determined to be invalid.

If the input image 252 is the processed image based on the original image 251, they are somewhat similar to each other. Hence, a condition (hereinafter referred to as a third condition) under which the input images 251 and 252 are similar to each other may be set, and, if the third condition is satisfied, the link information 281 may be determined to be valid whereas, if the third condition is not satisfied, the link information 281 may be determined to be invalid. As the method of determining whether or not the input images 251 and 252 are similar to each other, an arbitrary determination method including a known method (for example, a method disclosed in JP-A-2006-140559 or JP-A-2006-246127) can be utilized. The image feature quantities of the input images 251 and 252 are individually extracted from the image data on the input images 251 and 252, and the image feature qualities of the input images 251 and 252 are compared with each other, and thus it is possible to determine whether or not the input image 251 and 252 are similar to each other.

Only if any two of the first to third conditions are satisfied, the link information 281 may be determined to be valid, or only if all the first to third conditions are satisfied, the link information 281 may be determined to be valid.

If the link information 281 is determined to be valid, the reliability of the event in which the input image 252 is the processed image based on the original image 251 is determined to be high, and the slide show control portion 94 can perform the slide show reproduction as described in the specific procedures B₁ to B₃. On the other hand, if the link information 281 is determined to be invalid, the reliability of the event in which the input image 252 is the processed image based on the original image 251 is determined to be low, and the slide show control portion 94 can ignore the presence of the link information 281 and perform the slide show reproduction.

If, as shown in FIG. 46B, not only the link information 281 is stored in the header region of the image file 271 but also link information 282 is stored in the header region of the image file 272, the link information 281 and the link information 282 are checked against each other, and thus it is possible to further strengthen the determination as to whether the reliability is high or low.

### Fourth Embodiment

A fourth embodiment of the present invention will be described. The fourth embodiment is based on the third embodiment; with respect to what is not particularly described in the fourth embodiment, unless a contradiction arises, the description of the third embodiment is also applied to that of the fourth embodiment.

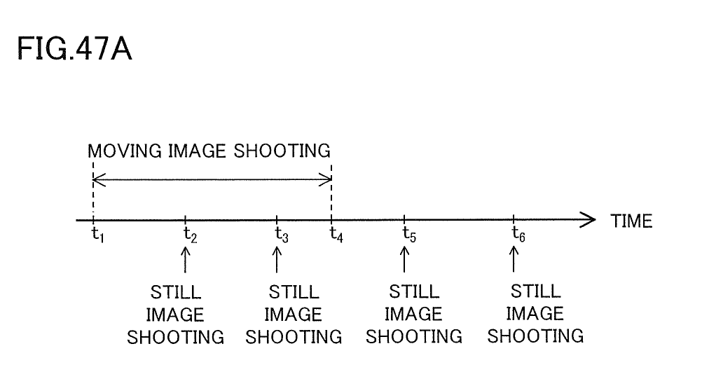

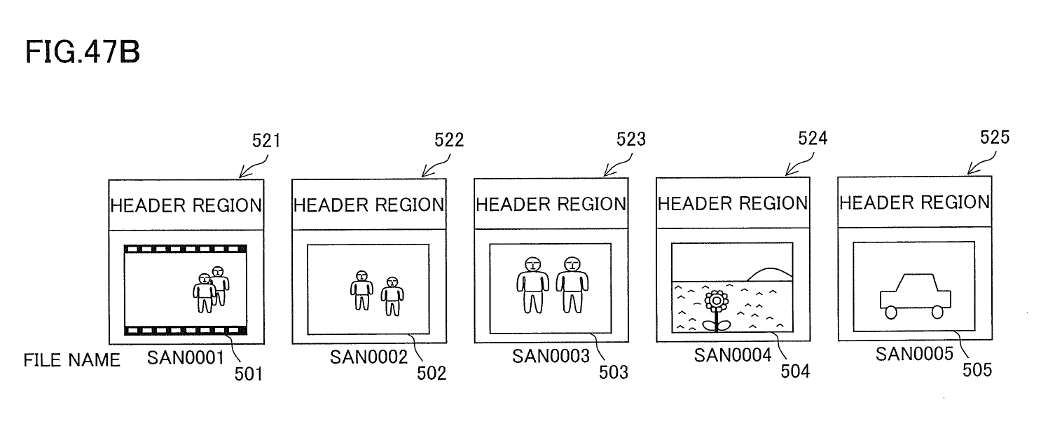

In the fourth embodiment, it is assumed that shooting is performed in the shooting order as shown in FIG. 47A, and that, consequently, input images 501 to 505 shown in FIG. 47B can be obtained. The input image 501 is a moving image, and the input images 502 to 505 are still images. Hence, in the following description, the input image 501 may be referred to as the moving image 501, and the input images 502 to 505 may be referred to as the still images 502 to 505. Image data on the input images 501 to 505 is stored in the body regions of image files 521 to 525, and is recorded in the recording medium 16.

It is assumed that, as time goes by, times t₁, t₂, t₃, t₄, t₅ and t₆ come in this order. It is assumed that a time period from the time t₁ to the time t₄ is the shooting time period of the moving image 501, and that, at the times t₂ and t₃ in the shooting time period of the moving image 501, the still images 502 and 503 are shot, respectively. From RAW data at the time t₂, it is possible not only to generate the frame of the moving image 501 at the time t₂ but also to generate the still image 502 (the same is true of the time t₃). It is assumed that, after the completion of shooting of the moving image 501, the still images 504 and 505 are shot at the times t₅ and t₆, respectively.

Here, it is assumed that shooting time data on the moving image 501 indicates the shooting start time t₁ of the moving image 501. Hence, among the input images 501 to 505, the shooting time of the input image 501 is the earliest. As in the third embodiment, file numbers can be included in the file names of the image files 521 to 525. Here, it is assumed that the file numbers “1”, “2”, “3”, “4” and “5” are given to input images in order from the input image whose shooting time is the earliest to the input image whose shooting time is the latest. In other words, the file numbers “1”, “2”, “3”, “4” and “5” are allocated to the file names of the image files 521, 522, 523, 524 and 525, respectively. In the example of FIG. 47B, each file name is configured by placing “00” to the front of each file number and further placing “SAN” to the front of “00”.

The extensions of file names usually differ between the image file of a moving image and the image file of a still image. Hence, the image file of a moving image and the image file of a still image both of which have a common file number can be simultaneously stored in the recording medium 16. Here, however, it is assumed that, as described above, different file numbers are given to the input images 501 to 505.

The user uses the operation portion 17 or the touch panel 19, and thereby can provide an instruction to perform the slide show reproduction in which the input images 501 to 505 are included in the reproduction target. The reproduction of the input image 501 while the slide show reproduction is being performed is the reproduction of a typical frame (for example, the first frame) of the moving image as the input image 501 or the reproduction of part or all of the moving image as the input image 501. When the instruction to perform the slide show reproduction is provided, the slide show control portion 94 (see FIG. 35) can perform basic slide show reproduction α₂ that is one type of slide show reproduction.

In the basic slide show reproduction α₂, the input images 501 to 505 are simply arranged in order of file number, and they are sequentially reproduced one by one. Specifically, the input images 501 to 505 are sequentially reproduced such that an input image to which a smaller file number is given is reproduced earlier. In other words, the reproduction places of the first, the second, the third, the fourth, the fifth, . . . are given to input images in ascending order of file number. As described in the third embodiment, the input images are sequentially reproduced in ascending order of reproduction place (the same is true of the improved slide show reproduction β₂ and the like, which will be described later).

Alternatively, in the basic slide show reproduction α₂, the input images 501 to 505 are simply arranged in order of shooting time, and they are sequentially reproduced. Specifically, the input images 501 to 505 are sequentially reproduced such that an input image corresponding to an earlier shooting time is reproduced earlier. In other words, the reproduction places of the first, the second, the third, the fourth, the fifth, . . . are given to input images in order from the input image corresponding to the earliest shooting time to the input image corresponding to the latest shooting time.

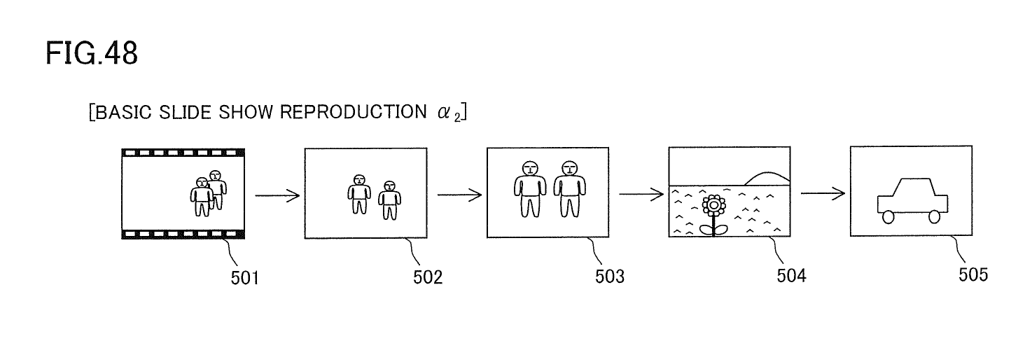

In all cases, in the basic slide show reproduction α₂, the reproduction order of the input images 501 to 505 is determined based on only the file numbers of the input images 501 to 505 or only the shooting times of the input images 501 to 505; consequently, as shown in FIG. 48, the input images 501, 502, 503, 504 and 505 are sequentially reproduced in this order.

In the following description, an input image that is shot in the shooting time period of a moving image and that is a still image is particularly referred to as a target still image, and an input image in which one or more target still images are shot in the shooting time period of the input image itself and that is a moving image is referred to as a target moving image. Hence, the input image 501 is the target moving image, and the input images 502 and 503 are the target still images.

There are several points in the basic slide show reproduction α₂ that need to be improved. The slide show control portion 94 can also perform the improved slide show reproduction β₂ that has benefits as compared with the basic slide show reproduction α₂. The improved slide show reproduction β₂ is also one type of slide show reproduction. In the following description of the fourth embodiment, unless particularly otherwise specified, the improved slide show reproduction β₂ is assumed to be performed as the slide show reproduction.

In order to realize the improved slide show reproduction β₂, the link information need to be generated and recorded by the link information processing portion 92 of FIG. 35. As in the third embodiment, the link information indicates a correspondence relationship between a plurality of input images; the link information can also be said to indicate a correspondence relationship between a plurality of image files. As the method of generating and recording the link information according to the fourth embodiment, any one of link methods D₁ to D₃ can be employed. The link methods D₁ to D₃ are similar to the link methods A₁ to A₃ of FIGS. 38A to 38C, respectively.

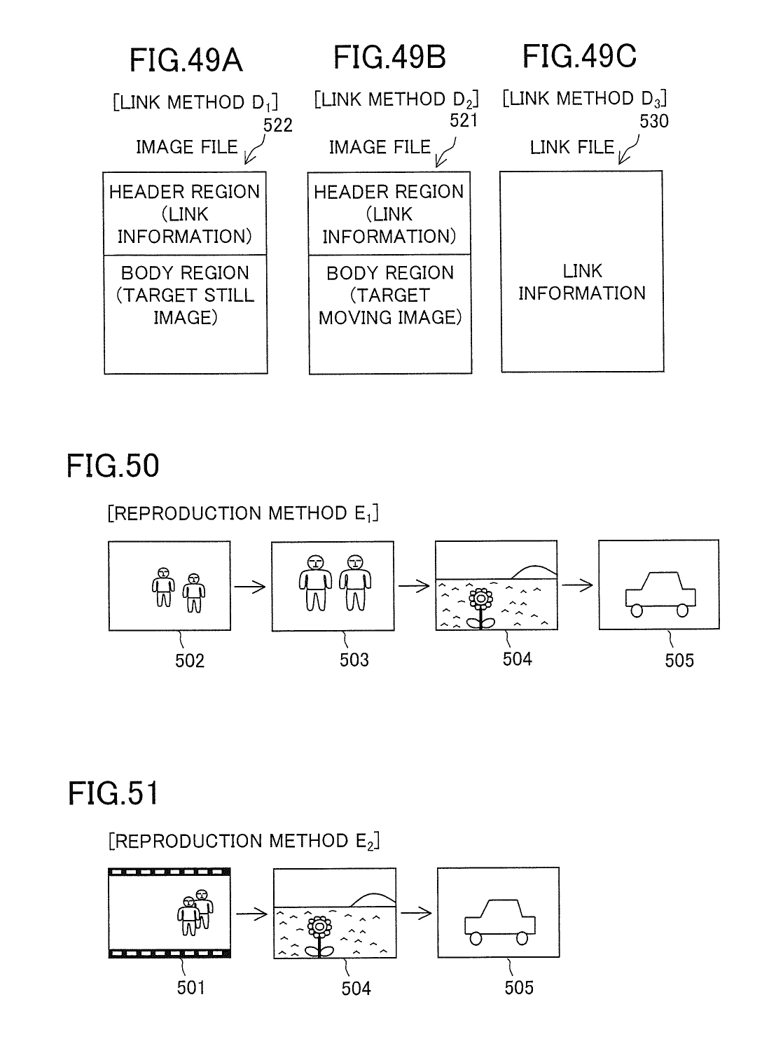

In the link method D₁, as shown in FIG. 49A, the link information is stored in the header region of the image file 522 that is the image file of a target still image, and is recorded in the recording medium 16. Likewise, the link information is also stored in the header region of the image file 523. The link information stored in the header regions of the image files 522 and 523 includes, for example, the file name of the image file 521.

In the link method D₂, as shown in FIG. 49B, the link information is stored in the header region of the image file 521 that is the image file of a target moving image, and is recorded in the recording medium 16. The link information stored in the header region of the image file 521 includes, for example, the file names of the image files 522 and 523.

In the link method D₃, as shown in FIG. 49C, a link file 530 that differs from the image files 521 to 525 is produced by the link information processing portion 92, and the link information is stored in the link file 530. The link file 530 including the link information is recorded in the recording medium 16.

Even when any one of the link methods D₁ to D₃ is employed, the link information indicates that the input image 501 is a target moving image and that the input images 502 and 503 are target still images that are shot in the shooting time period of the target moving image 501.

The specific procedure of the improved slide show reproduction β₂ is the same as any one of the specific procedures B₁ to B₃, which are described in the third embodiment with reference to FIG. 39, 44 or 45; the application B₄ on the strengthening of the reliability of the link information can also be applied to the improved slide show reproduction β₂. When the description of the specific procedures B₁ to B₃ and the application B₄ is applied to the improved slide show reproduction β₂, the original image and the processed image are preferably replaced with the target moving image and the target still image, respectively. When the specific procedure B₁ corresponding to FIG. 39 is applied to the improved slide show reproduction β₂, the link method D₁ corresponding to FIG. 49A can be employed; when the specific procedure B₂ corresponding to FIG. 44 is applied to the improved slide show reproduction β₂, the link method D₂ corresponding to FIG. 49B can be employed; the specific procedure B₃ corresponding to FIG. 45 is applied to the improved slide show reproduction β₂, the link method D₃ corresponding to FIG. 49C can be employed.

In the improved slide show reproduction β₂, any one of the following reproduction methods E₁ to E₅ can be employed.

Reproduction Method E₁

The reproduction method E₁ will be described. In the reproduction method E₁, the slide show control portion 94 identifies, based on the link information, which input image is a target moving image, omits the target moving image from the reproduction target and then performs the slide show reproduction. Hence, the input image 501 is omitted from the reproduction target and is not reproduced, and the input images 502 to 505 are sequentially reproduced as the reproduction target. The slide show control portion 94 can set the reproduction order of the input images 502 to 505 in the same method as in the basic slide show reproduction α₂. Hence, for example, as shown in FIG. 50, the input images 502, 503, 504 and 505 can be sequentially reproduced in this order.

Reproduction Method E₂

The reproduction method E₂ will be described. In the reproduction method E₂, the slide show control portion 94 identifies, based on the link information, which input image is a target still image, omits the target still image from the reproduction target and then performs the slide show reproduction. Hence, the input images 502 and 503 are omitted from the reproduction target and are not reproduced, and the input images 501, 504 and 505 are sequentially reproduced as the reproduction target. The slide show control portion 94 can set the reproduction order of the input images 501, 504 and 505 in the same method as in the basic slide show reproduction α₂. Hence, for example, as shown in FIG. 51, the input images 501, 504 and 505 can be sequentially reproduced in this order.

Since, in the basic slide show reproduction α₂, as shown in FIG. 48, the target moving image 501 and the target still images 502 and 503 that are the same as or similar to frames in the target moving image 501 are separately reproduced, the details of the reproduction can be redundant. Since, in the reproduction method E₁ or E₂, the reproduction of any one of the target moving image and the target still image is omitted, such redundancy is expected to be improved. Although, in the example of FIG. 51, the number of target still images whose reproduction is omitted is two, the number of target still images whose reproduction is omitted may be either one or three or more.

Reproduction Method E₃

The reproduction method E₃ will be described. In the reproduction method E₃, the slide show control portion 94 identifies, based on the link information, which input image is a target moving image and which input image is a target still image and simultaneously reproduces the target moving image and the target still image.

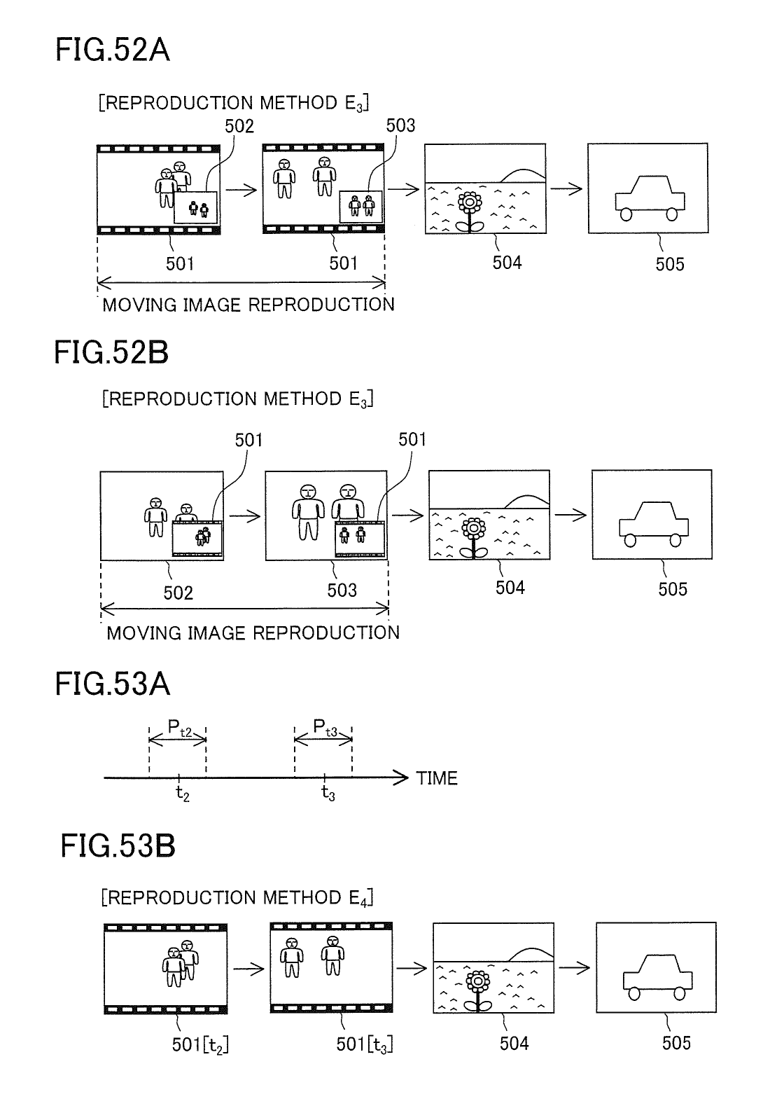

Specifically, for example, as shown in FIG. 52A, in all or part of the shooting time period of the input image 501, the input image 501 is reproduced as a moving image, and then the input images 504 and 505 are sequentially reproduced. While the input image 501 is being reproduced as a moving image, the input images 502 and 503 are superimposed on the input image 501 and are reproduced. Specifically, for example, when the input image 501 is reproduced, different first and second division display regions are set in the display region of the display screen, and the input image 501 is reproduced as a moving image in the first division display region and simultaneously, the input images 502 and 503 are sequentially reproduced as still images in the second division display region.

Alternatively, for example, as shown in FIG. 52B, the moving image 501 is not singly reproduced, and the input images 502, 503, 504 and 505 are sequentially reproduced in this order. While the input images 502 and 503 are being reproduced, the input image 501 is reproduced as a moving image while being superimposed on the input images 502 and 503. Specifically, for example, when the input images 502 and 503 are reproduced, the different first and second division display regions are set in the display region of the display screen, and the input images 502 and 503 are sequentially reproduced as still images in the first division display region and simultaneously, the input image 501 is reproduced as a moving image in the second division display region.

Which of the target moving image and the target still image is allocated to the first division display region is only different between the example shown in FIG. 52A and the example shown in FIG. 52B, and they can also be said to be substantially equivalent to each other. The first and second division display regions may be display regions that are adjacent to each other in the horizontal direction or the vertical direction of the display screen. In this case, the target moving image and the target still image are displayed side by side on the display screen.

Since, in the basic slide show reproduction α₂, the target moving image 501 and the target still images 502 and 503 that are the same as or similar to frames in the target moving image 501 are separately reproduced, the details of the reproduction can be redundant. Since, in the reproduction method E₃, the target moving image and the target still image are simultaneously reproduced, such redundancy is expected to be improved.

Reproduction Method E₄

The reproduction method E₄ will be described. In the reproduction method E₄, the slide show control portion 94 identifies, based on the link information, which input image is a target moving image and which input image is a target still image. Then, the slide show control portion 94 sets a specific time period with reference to the shooting time of the target still image, and reproduces, in the slide show reproduction, the target moving image in the specific time period.

The specific example of the reproduction method E₄ will be described with reference to FIGS. 53A and 53B. The slide show control portion 94 recognizes, from the link information, that the input image 501 is a target moving image and that the input images 502 and 503 are target still images, reads the shooting time data from the image files 522 and 523 storing the input images 502 and 503 and thereby recognizes the shooting times t₂ and t₃ of the input images 502 and 503. Then, the slide show control portion 54 sets a specific time period Pₜ₂ with reference to the shooting time t₂ and a specific time period Pₜ₃ with reference to the shooting time t₃. The specific time period Pₜ₂ is a time period from a time (t₂−Δt_{A}) to the time t₂, a time period from the time t₂ to a time (t₂+Δt_{B}) or a time period from the time (t₂−Δt_{A}) to the time (t₂+Δt_{B}). The time (t₂−Δt_{A}) indicates a time that is Δt_{A} seconds ahead of the time t₂; the time (t₂+Δt_{B}) indicates a time that is Δt_{B} seconds behind the time t₂. Here, Δt_{A} and Δt_{B} have positive values; Δt_{A} and Δt_{B} may be equal to each other or Δt_{A} and Δt_{B} may fail to be equal to each other. For convenience, the moving image 501 in the specific time period Pₜ₂ and the moving image 501 in the specific time period Pₜ₃ are referred to as moving images 501[t₂] and 501[t₃], respectively.

After the setting of the specific time periods Pₜ₂ and Pₜ₃, in the slide show reproduction, as shown in FIG. 53B, the slide show control portion 94 first reproduces the moving image 501[t₂], and then reproduces the moving image 501[t₃]. Thereafter, the input images 504 and 505 are sequentially reproduced.

When, in the slide show reproduction, the entire moving image is reproduced, the necessary reproduction time period is relatively long, and the details of the reproduction can be redundant. On the other hand, it is highly likely that a shooting scene at a timing when a target still image is shot is a scene which is relatively important for a photographer. In view of this, when a moving image is reproduced in the slid show reproduction, as described above, only part of the moving image at times around the shooting time of the target still image is reproduced. Thus, only the main part is reproduced, and the redundancy of the details of the reproduction is improved.

Reproduction Method E₅

The reproduction method E₅ will be described. In the reproduction method E₅, the slide show control portion 94 identifies, based on the link information, which input image is a target moving image and which input image is a target still image. Then, when the slide show control portion 94 reproduces the target moving image in the slide show reproduction, the slide show control portion 94 inserts the reproduction of the target still image while the target moving image is being reproduced.

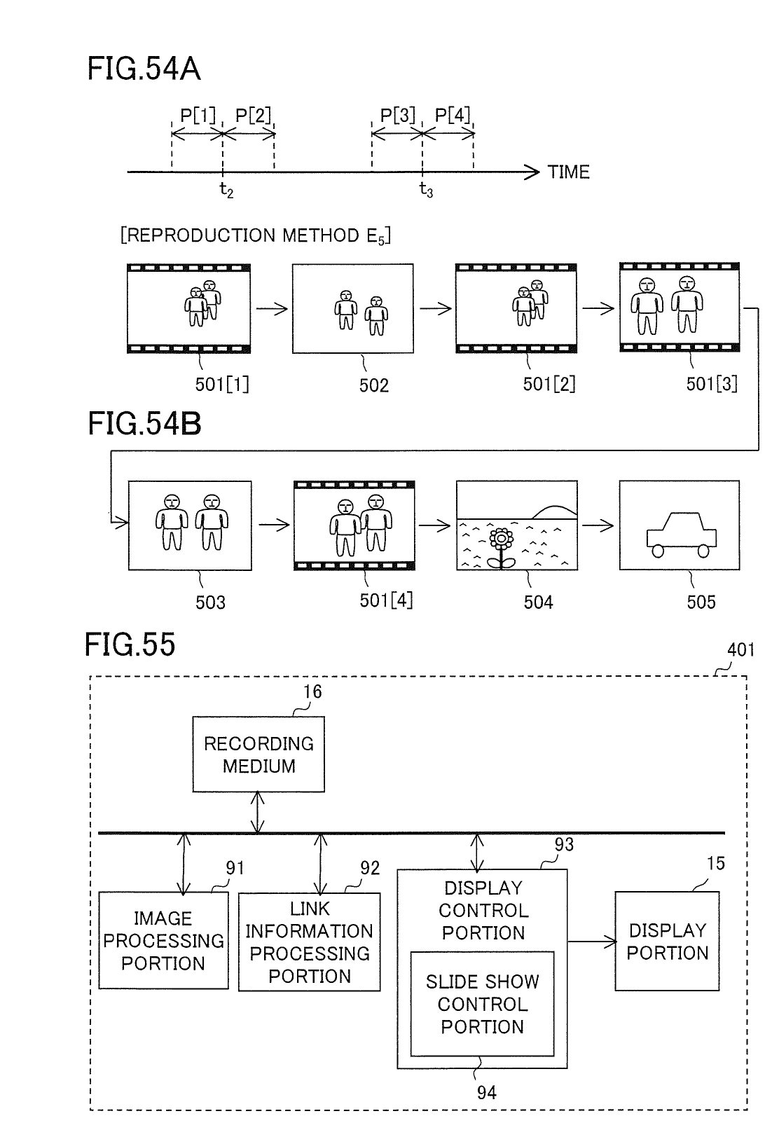

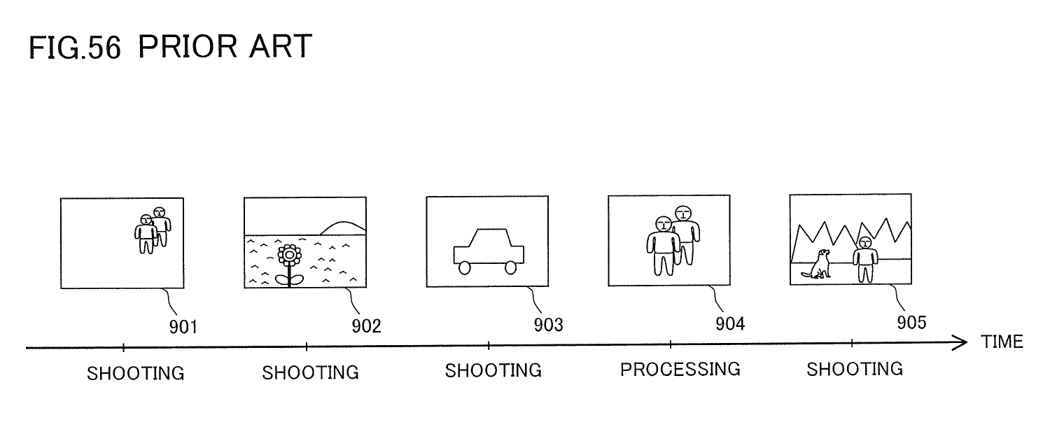

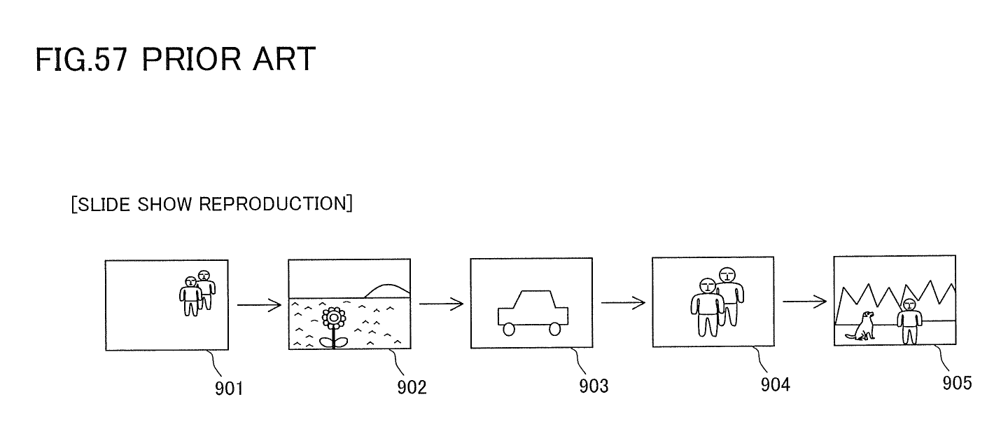

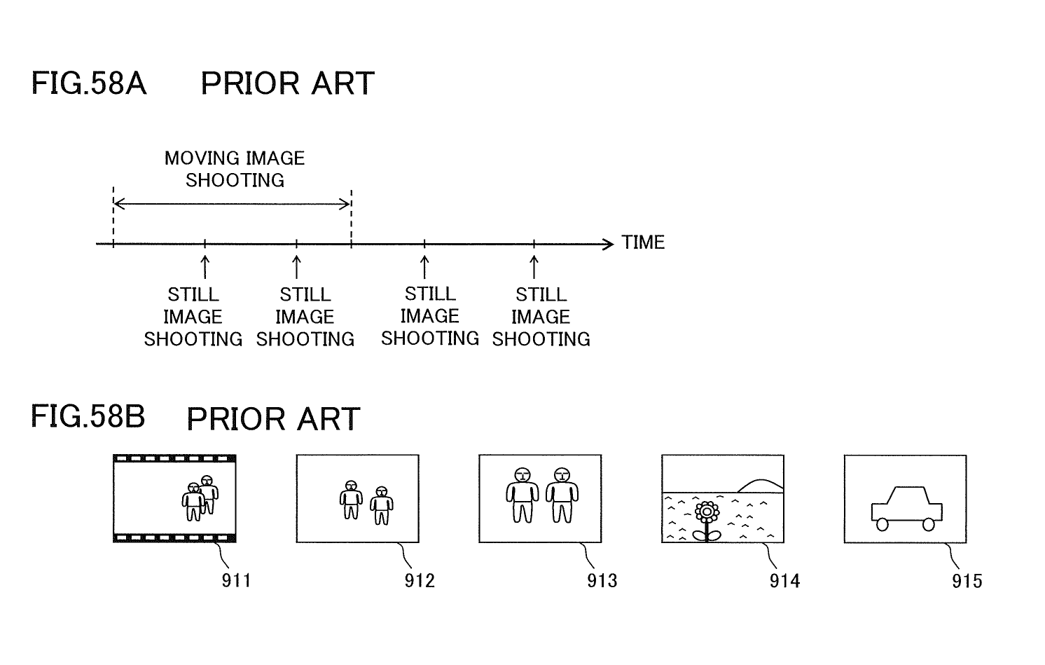

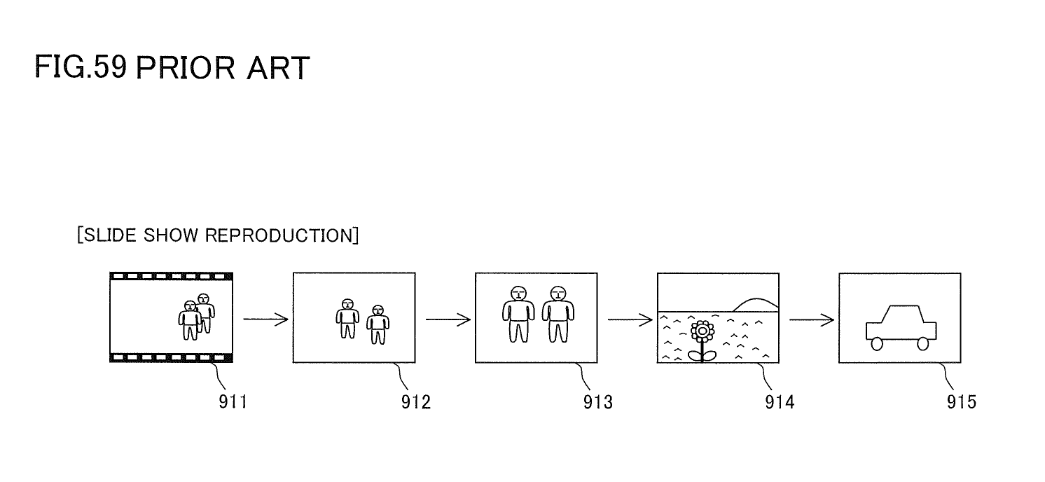

The specific example of the reproduction method E₅ will be described with reference to FIGS. 54A and 54B. The slide show control portion 94 recognizes, from the link information, that the input image 501 is a target moving image and that the input images 502 and 503 are target still images, reads the shooting time data from the image files 522 and 523 storing the input images 502 and 503 and thereby recognizes the shooting times t₂ and t₃ of the input images 502 and 503. Then, the slide show control portion 94 sets time periods P[1] and P[2] with reference to the shooting time t₂, and sets time periods P[3] and P[4] with reference to the shooting time t₃. The time periods P[1] and P[2] are a time period from the time (t₂−Δt_{A}) to the time t₂ and a time period from the time t₂ to the time (t₂+Δt_{B}), respectively. The time periods P[3] and P[4] are a time period from the time (t₃−Δt_{A}) to the time t₃ and a time period from the time t₃ to the time (t₃+Δt_{B}), respectively. For convenience, the moving image 501 in the time period P[1], the moving image 501 in the time period P[2], the moving image 501 in the time period P[3] and the moving image 501 in the time period P[4] are referred to as moving images 501[1], 501[2], 501[3] and 501[4], respectively.

After the setting of the time periods P[1] to P[4], in the slide show reproduction, as shown in FIG. 54B, the slide show control portion 94 first reproduces the moving image 501[1], secondly reproduces the target still image 502, thirdly reproduces the moving image 501[2], fourthly reproduces the moving image 501[3], fifthly reproduces the input image 503, sixthly reproduces the moving image 501[4] and then sequentially reproduces the input images 504 and 505. However, the reproduction of the moving images 501[1] and 501[3] can be omitted or the reproduction of the moving images 501[2] and 501[4] can be omitted.

As described above, when the moving image 501 is reproduced in the slide show reproduction, the reproduction of the target still images 502 and 503 is inserted while the moving image 501 is being reproduced. In this way, as in the reproduction method E₄, only the main part of the moving image is reproduced, and the redundancy of the details of the reproduction is improved. A time relationship between the target moving image and the target still image is easily understood by the viewer of the slide show, and image effects similar to those of a story in the slide show can be enhanced.

<<Variations>>

In the embodiments of the present invention, various modifications are possible as necessary within the range of technical ideas indicated by the scope of claims. The embodiments described above are simply examples of embodiments of the present invention; the significance of terms of the present invention or constituent requirements is not limited to the description of the above embodiments. The specific values indicated in the above description are simply examples; naturally, they can be changed to various different values. Explanatory notes 1 to 3 will be described below as explanatory matters that can be applied the embodiments described above. The subject matters of the explanatory notes can freely be combined together unless a contradiction arises.

[Explanatory Note 1]

Although, in each of the embodiments described above, basically, the input images are sequentially reproduced one by one in the slide show reproduction, in the slide show reproduction, the input images may be sequentially reproduced in groups of k sheets (k is an integer of two or more).

[Explanatory Note 2]

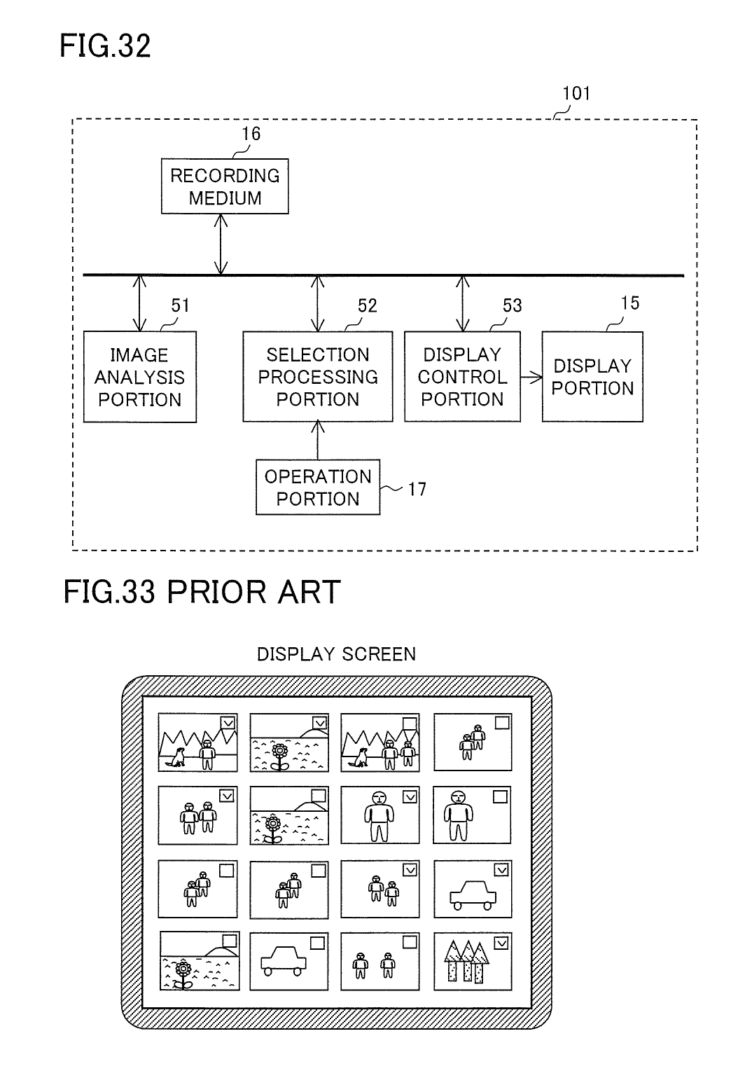

When an input image is reproduced in the image sensing device 1, the image sensing device 1 functions as an image reproduction device. As shown in FIG. 32, an electronic apparatus 101 different from the image sensing device 1 may be provided with the image analysis portion 51, the selection processing portion 52, the display control portion 53, the display portion 15 and the recording medium 16, as shown in FIG. 6, and the operation portion 17, as shown in FIG. 1, and thus the slide show reproduction described above may be performed on the electronic apparatus 101. As shown in FIG. 55, an electronic apparatus 401 different from the image sensing device 1 may be provided with the image processing portion 91, the link information processing portion 92, the display control portion 93, the display portion 15 and the recording medium 16, as shown in FIG. 35, and thus the slide show reproduction described above may be performed on the electronic apparatus 401. The electronic apparatus 101 or 401 that performs the slide show reproduction can be referred as an image reproduction device. For example, the electronic apparatus 101 or 401 is a personal computer, a portable information terminal or a mobile telephone. The image sensing device 1 is also one type of electronic apparatus.

[Explanatory Note 3]

The image sensing device 1 and the electronic apparatus (101 or 401) can be formed with hardware or a combination of hardware and software. When the image sensing device 1 and the electronic apparatus (101 or 401) are formed with software, the block diagram of a portion realized by the software represents a functional block diagram of the portion. In particular, all or part of a function realized with the image analysis portion 51, the selection processing portion 52 and the display control portion 53 or all or part of a function realized with the image processing portion 91, the link information processing portion 92 and the display control portion 93 may be described as a program, the program may be executed on a program execution device (for example, a computer) and thus all or part of the function may be realized.

What is claimed is:

1. An image reproduction device comprising:
a target image selection portion that selects, according to a selection operation, n sheets of target images from m sheets of input images (m and n are integers of two or more, and m>n), the selected n sheets of target images being sequentially displayed on a display screen such that slide show reproduction is performed;
an image classification portion that classifies the m sheets of input images into a plurality of classes based on an image feature quantity extracted from each of the input images; and
a display control portion that displays, when an input of the selection operation is received, the input images on the display screen in an arrangement based on a result of the classification of the image classification portion.

2. The image reproduction device of claim 1,
wherein the display control portion divides, when the input of the selection operation is received, a display region of the display screen into a plurality of class display regions, and displays the input images on the display screen such that input images belonging to a common class are displayed in a common class display region.

3. The image reproduction device of claim 1,
wherein the display control portion displays, when the input of the selection operation is received, the input images on the display screen such that a plurality of the target images selected are displayed in a predetermined display region on the display screen.

4. The image reproduction device of claim 1,
wherein an input image, among the m sheets of input images, that is not selected as one of the target images is reproduced, in the slide show reproduction, in a reproduction time period shorter than a reproduction time period of the target image.

5. An image reproduction device comprising:
a target image selection portion that selects, according to a selection operation, n sheets of target images from m sheets of input images (m and n are integers of two or more, and m>n), the selected n sheets of target images being sequentially displayed on a display screen such that slide show reproduction is performed,
wherein, when a predetermined operation is received while a p-th round of slide show reproduction is being performed, an input image that is not selected as one of the target images in the p-th round of slide show reproduction is displayed, and selection of target images in a (p+1)-th round of slide show reproduction or in rounds of slide show reproduction subsequent to the (p+1)-th round of slide show reproduction is received (p is a natural number).

6. The image reproduction device of claim 5, further comprising:
an image classification portion that classifies the m sheets of input images into a plurality of classes based on an image feature quantity extracted from each of the input images,
wherein, when the predetermined operation is received while the p-th round of slide show reproduction is being performed and a first input image included in the m sheets of input images is being displayed, an input image of a class to which the first input image belongs is displayed, and the selection of the target images in the (p+1)-th round of slide show reproduction or in the rounds of slide show reproduction subsequent to the (p+1)-th round of slide show reproduction is received.

7. The image reproduction device of claim 5,
wherein an input image, among the m sheets of input images, that is not selected as one of the target images in an i-th round of slide show reproduction is reproduced, in the i-th round of slide show reproduction, in a reproduction time period shorter than a reproduction time period of the target image (i is a natural number).

8. An image reproduction method comprising:
a target image selection step of selecting, according to a selection operation, n sheets of target images from m sheets of input images (m and n are integers of two or more, and m>n);
a reproduction step of sequentially displaying the selected n sheets of target images on a display screen such that slide show reproduction is performed;
an image classification step of classifying the m sheets of input images into a plurality of classes based on an image feature quantity extracted from each of the input images; and
a display control step of displaying, when an input of the selection operation is received, the input images on the display screen in an arrangement based on a result of the classification of the image classification step.

9. A program that instructs a computer to execute the target image selection step, the reproduction step, the image classification step and the display control step of claim 8.

10. An image reproduction method comprising:
a target image selection step of selecting, according to a selection operation, n sheets of target images from m sheets of input images (m and n are integers of two or more, and m>n);
a reproduction step of sequentially displaying the selected n sheets of target images on a display screen such that slide show reproduction is performed; and
a selection reception step of displaying, when a predetermined operation is received while a p-th round of slide show reproduction is being performed, an input image that is not selected as one of the target images in the p-th round of slide show reproduction, and of receiving selection of target images in a (p+1)-th round of slide show reproduction or in rounds of slide show reproduction subsequent to the (p+1)-th round of slide show reproduction (p is a natural number).

11. A program that instructs a computer to execute the target image selection step, the reproduction step and the selection reception step of claim 10.

12. An image reproduction device that reproduces a plurality of input images including first and second input images, the image reproduction device comprising:
a reproduction control portion that performs slide show reproduction in which the plurality of input images are sequentially reproduced; and
a link information processing portion that generates link information corresponding to a relationship between the first and second input images when the second input image is an image based on the first input image or when the first input image is a moving image and the second input image is a still image shot in a shooting time period of the first input image,
wherein the reproduction control portion performs, when the link information is present, the slide show reproduction based on the link information.

13. The image reproduction device of claim 12,
wherein, when the second input image is the image based on the first input image or when the first input image is the moving image and the second input image is the still image shot in the shooting time period of the first input image, the reproduction control portion omits any one of the first and second input images from a reproduction target in the slide show reproduction.

14. The image reproduction device of claim 12,
wherein, when the second input image is the image based on the first input image or when the first input image is the moving image and the second input image is the still image shot in the shooting time period of the first input image, the reproduction control portion simultaneously reproduces the first and second input images in the slide show reproduction.

15. The image reproduction device of claim 12,
wherein an order of reproduction of the plurality of input images in the slide show reproduction differs depending on whether or not the second input image is the image based on the first input image, and
when the second input image is based on the first input image, the reproduction control portion determines the order of reproduction such that the first and second input images are continuously reproduced in the slide show reproduction.

16. The image reproduction device of claim 12,
wherein, when the first input image is the moving image and the second input image is the still image shot in the shooting time period of the first input image, the reproduction control portion sets a specific time period with reference to a shooting time of the second input image and reproduces, in the slide show reproduction, the moving image in the specific time period.

17. The image reproduction device of claim 12,
wherein, when the first input image is the moving image and the second input image is the still image shot in the shooting time period of the first input image, the reproduction control portion reproduces, in the slide show reproduction, the moving image and inserts reproduction of the still image while the moving image is being reproduced.

18. The image reproduction device of claim 12,
wherein the link information processing portion stores the link information in a first image file storing image data on the first input image, in a second image file storing image data on the second input image or in a file different from the first and second image files, and records the link information in a recording medium.

19. The image reproduction device of claim 12,
wherein the image based on the first input image is an image that is obtained by processing the first input image.

20. An image reproduction method that reproduces a plurality of input images including first and second input images, the image reproduction method comprising:
a reproduction control step of performing slide show reproduction in which the plurality of input images are sequentially reproduced; and
a link information processing step of generating link information corresponding to a relationship between the first and second input images when the second input image is an image based on the first input image or when the first input image is a moving image and the second input image is a still image shot in a shooting time period of the first input image,
wherein, in the reproduction control step, when the link information is present, the slide show reproduction is performed based on the link information.

21. A program that instructs a computer to execute the reproduction control step and the link information processing step of claim 20.
